(19) United States
(12) Patent Application Publication
(10) Pub. No.: US 2008/0183905 A1
(43) Pub. Date: Jul. 31, 2008

(54) SYSTEM AND METHOD OF SEAMLESSLY SWITCHING BETWEEN EMBEDDED AND EXTERNAL FUNCTIONS ON A MULTI-FUNCTION PRINTER

(76) Inventor: Hiroshi KITADA, Tuckahoe, NY (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/669,721

(22) Filed: Jan. 31, 2007

(51) Int. Cl. G06F 3/00

(52) U.S. Cl. 710/8; 710/15

(57) ABSTRACT

A method and apparatus for launching a host application of an image handling device, determining external functions for the image handling device, storing information regarding available external functions determined by the determining in a configuration file, presenting a graphical interface that includes selectable graphical indicia representing each function accessible on the image handling device including the at least one embedded function and the available external functions and executing the at least one embedded function and the determined external functions based on a selection of the corresponding graphical indicia.

### BACKGROUND OF THE INVENTIONS

The present invention relates to a system and method of seamlessly switching between embedded and external functions on a multi-function printer.

Conventionally, Multi-Function Printers (MFPs) could be configured to use embedded functions, functions that were installed in a storage device in the MFP, or alternatively MFPs could be configured to use predetermined external functions, the predetermined external functions being functions that were installed on the MFP but used an external server to accomplish functions other than image scanning/printing. However, once an MFP was configured to use embedded functions, it was not possible for the user to use any external functions. Similarly, once a MFP was configured to use the predetermined external functions the user was unable to use the embedded functions. Thus when the external server became unavailable the user was unable to use the function of the MFP without a service person physically visiting the MFP to change the configuration of the MFP.

Additionally, when the MFP was configured to use the predetermined external functions each time a new external function was added to a network accessible by the MFP, a service person was required to physically visit the site of the MFP to upgrade the configuration of the MFP to include the newly added external function.

### SUMMARY OF THE INVENTIONS

The present inventions provide, inter alia, a method including the step of launching a host application of an image handling device. The image handling device includes at least one embedded function and a network interface. The method further includes determining external functions for the image handling device. The external functions utilize the network interface and including operations which are performed remotely from the image handling device. The method also includes storing information regarding available external functions determined by the determining in a configuration file and presenting a graphical interface that includes selectable graphical indicia representing each function accessible on the image handling device including the at least one embedded function and the available external functions. In addition, the method includes executing the at least one embedded function and the determined external functions based on a selection of the corresponding graphical indicia.

Also provided by the present inventions is an image handling device that includes a host application configured to provide a core service of the image handling device and including at least one embedded function and a network interface. Also included in the image handling device is an external function unit configured to determine external functions for the image handling device, the external functions utilizing the network interface and including operations which are performed remotely from the image handling device. A configuration file configured to store information regarding available external functions determined by the determining is included in the image handling device along with a display configured to present a graphical interface that includes selectable graphical indicia representing each function accessible on the image handling device including the at least one embedded function and the available external functions. In addition, an input unit configured to receive user input and to execute the selected at least one embedded function or the determined external function based on the selection of the corresponding graphical indicia is included in the image handling device.

It is to be understood that both the foregoing general description of the invention and the following detailed description are exemplary, but are not restrictive, of the invention.

### BRIEF DESCRIPTION OF SEVERAL VIEWS OF THE DRAWINGS

Other objects, features and advantages of the present invention will become more apparent from the following detailed description when read in conjunction with the accompanying drawings, in which:

FIG. 1 is a block diagram showing an office set-up which includes several MFPs;

FIG. 2 is a block diagram of an application layer of an MFP according to an exemplary embodiment of the present invention;

FIG. 3 is a block diagram showing a Unified Client Application according to an embodiment of the present invention;

FIG. 4 is a block diagram showing an embedded function according to an exemplary embodiment of the present invention;

FIG. 5 is a block diagram showing an example of the embedded function of the Document Mall application;

FIGS. 6A and 6B are process diagrams showing exemplary software architecture;

FIGS. 7A, 7B, 7C, 7D(i), 7D(ii), 7E, 7F(i), 7F(ii) and 7F(iii) are flowcharts showing a procedure of the process of the Server/Serverless Unified Client Main thread;

FIGS. 8A and 8B are a flowchart of the Server/Serverless Unified Client Upload thread;

FIG. 9 shows an exemplary project array window which allows the user to select a project;

FIG. 10 shows a main window which allows the user to select different services of the selected project;

FIGS. 11A-11F show an example of a config.xml file;

FIG. 12 is exemplary user interface of an eCabinet™ embedded function in which the eCabinet project main window and the eCabinet owner service window are displayed;

FIG. 13 is an exemplary user interface of an eCabinet embedded function in which the eCabinet project main window and eCabinet Folder service window are displayed;

FIG. 14 is an exemplary user interface of an eCabinet embedded function in which the eCabinet project main window and the scan settings service window are displayed;

FIG. 15 is an exemplary user interface of an eCabinet embedded function in which the eCabinet project main window and the scan settings service scan size sub-window are displayed;

FIG. 16 is an exemplary user interface of an eCabinet embedded function in which the eCabinet project main window and the job log service window are displayed;

FIG. 17 is an exemplary user interface of an Email embedded function in which the Email project main window and the Email selection window are displayed;

FIG. 18 is a block diagram showing a typical software configuration for a multi-function printer.

### DETAILED DESCRIPTION OF THE INVENTIONS

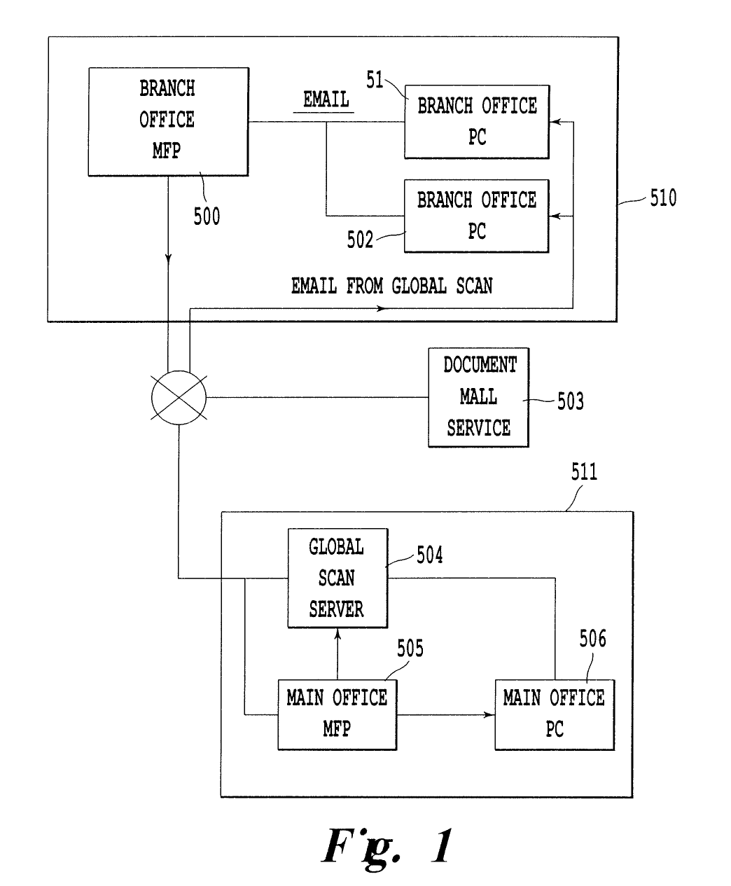

Referring now to the drawings wherein like reference numbers designate identical or corresponding parts throughout the several views and more particularly to FIG. 1 thereof, this is illustrated a typical set-up including a main office 511 and a branch office 510 remote from the main office 511. The branch office 510 includes a branch office MFP 500 and a number of branch office personal computers (PCs) 501-502. Connected via a network is the main office 511. The main office 511 includes a GlobalScan™ server 504, a main office MFP 505 and a main office PC 506. Also included external to the main office 511 and the branch office is a document mall server 503.

An embodiment of the present invention enables seamless integration of both embedded and external functions on the MFP 500. Embedded functions are the functions that are installed on the MFP and are performed locally on the MFP. The embedded functions can be implemented used a plug-in. External functions are functions that utilize an external server such as a globalscan server to perform the function. The MFP is any printer or copier which includes multiple functions such as scanning, printing and/or faxing. Additionally, the MFP described above may include a copier that scans and prints a document in response to a single command, as scanning and printing are distinct functions.

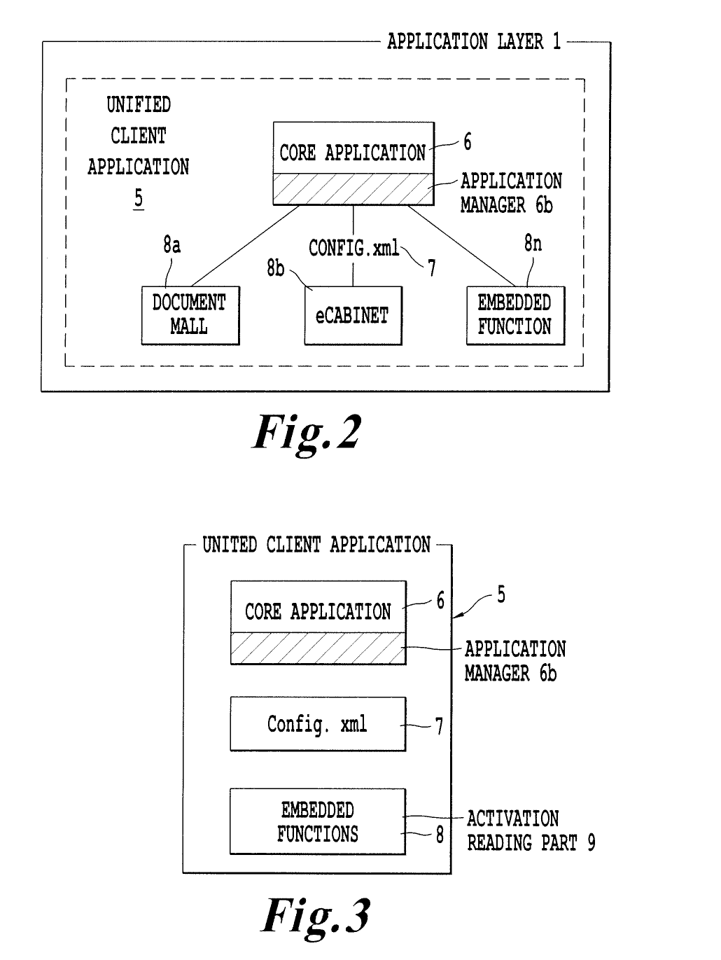

The embedded functions of the MFP are configured as follows. FIG. 2 shows an application layer 1 of an MFP including a unified client application 5. The unified client application 5 installed on a MFP includes a core application 6, the core application being an application that includes primary routines that serve the application. These primary routines typically carry out basic functions of the MFP including scanning, printing, copying, faxing, and communicating, for example. Included below the core application 6 is the activation manager 6b. The activation manager is the portion of the unified client application that determines the activation status of functions and corresponding services. In addition, the activation manager 6b generates a config.xml file 7 based on the determination of the activation status. The configuration file may be any type of configuration file including an extensible markup language such as XML, Standard Generalized Markup Language (SGML), GML, RDF/XML, RSS, Atom, MathML, XHTML, SVG, DSDL, XUL, MXML, EAD or Klip.

It should also be noted that according to one embodiment, the configuration file is able to be used in a mixed brand environment. Even if, for example, several different brands of copiers are used in an environment such as an office or a building, each unique brand will be able to utilize the configuration file. In addition each different MFP may be able to load the unified client architecture and the embedded functions. Thus, each copier or multi-function device will be able to have the same basic interface and commands limited only be the functionality of the specific copier or multi-function printer in question. According to an alternate embodiment, different configuration files can be used by different manufactures or models.

The activation manager 6b provides the ability to activate or de-activate any embedded functions installed on the MFP or any external function operable by the MFP. As a result, all available embedded functionalities can be pre-installed on the MFP at the factory. When a user takes delivery of the MFP, the MFP may have some of the embedded functions activated or none of the embedded functions activated. If none of the embedded functions are activated, the user can activate the embedded functions as the user sees fit, such as when the need arises.

Different types of activation schemes are also available. For example, the user may be able to activate embedded or external functions for a limited time on a trial basis. Alternatively, the user may be able to buy, lease, or license the use of the embedded or external functions for a one time use or a time-based use such as for a week or a month. This could be useful for organizations that have higher demand during certain times of the year such as during tax season.

Additionally, the activation manager enables different fee options to be used on the MFP. For example, a user may pay a monthly subscription fee for use of embedded or external functions. When the user no longer needs the embedded or external functions, the use can be discontinued via a central server using the activation manager 6b. Additionally, embedded or external functions can be de-activated based on expiration dates. For example, a user could buy a six month subscription to an embedded or external function, and once the six months have expired the embedded or external function can be deactivated.

Further, if the user has the ability to activate embedded or external functions (such as the user has financial decision making abilities) the activation manager 6b enables the user to activate embedded or external functions in different ways. For example, using a device attached to the MFP, a user's ability to buy activation could be verified. Devices such as a smart card, biometrics, PIN code, magnetic strip card or proximity card could be used as well as other existing ID verification systems to enable the purchase/activation.

With respect to the activation, in the event that a user has control over a number of MFPs, the activation process can be accomplished remotely and collectively. Thus, a large number of MFPs can have embedded or external functions activated virtually simultaneously using a remote station. This enables uniformity in an organization and also saves a significant amount of time as there is no need to visit each MFP to perform an activation or deactivation.

The config.xml file 7 includes settings regarding unified client application 5 in addition to activation information. Additionally, embedded functions 8a . . . n are controlled by the core application 6.

Different types of embedded functions can be installed in the unified client application 6. For example, in the present example depicted in FIG. 2, a Document Mall embedded function 8a, an eCabinet embedded function 8b and a generic embedded function 8n are installed.

Document Mall is an application for creating a secure online document storage, enabling an online shared workspace. Document Mall combines security with web-based document management and collaboration features delivered as an on-demand, document management and document imaging service.

Likewise, eCabinet is a network document repository that integrates with multi-function printers. eCabinet provides users with the ability to capture documents and automatically index them, providing archive security coupled with fast retrieval.

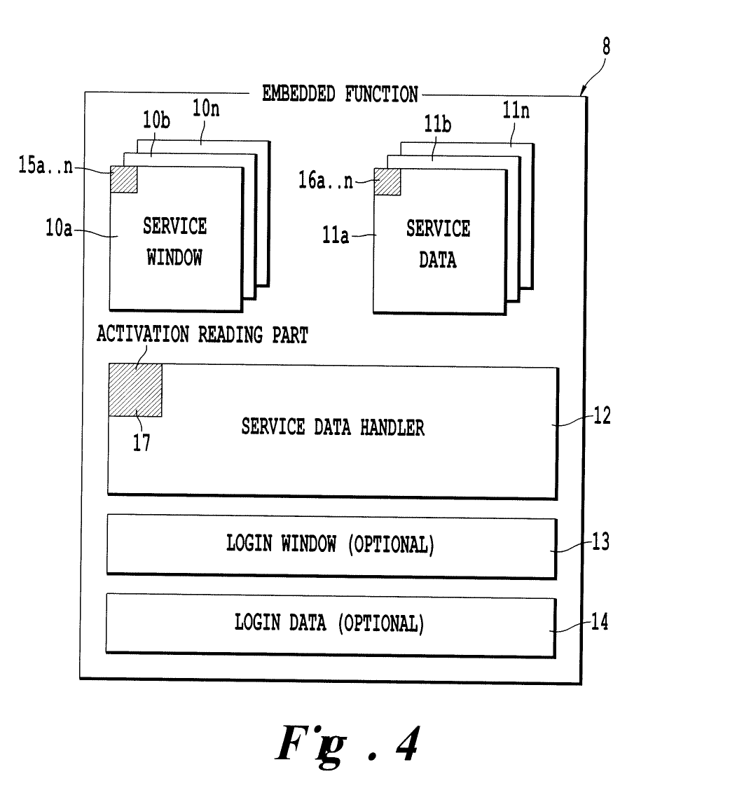

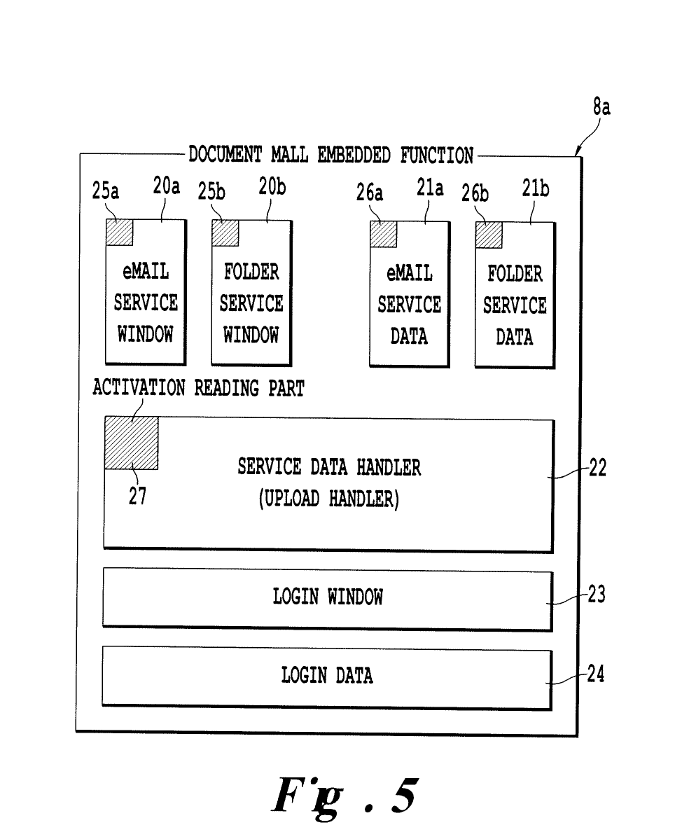

An embedded function generally includes programs or code for operating the hardware of the multi-function printer via the core application 6. An alternate illustration of the Unified Client application 5 shown in FIG. 2 is set forth in FIG. 3 which includes the core application 6, the activation manager 6b which, according to one exemplary embodiment, is separate from the core application, the config.xml file 7 including activation information and the embedded functions 8, the embedded functions including an activation reading part 9.

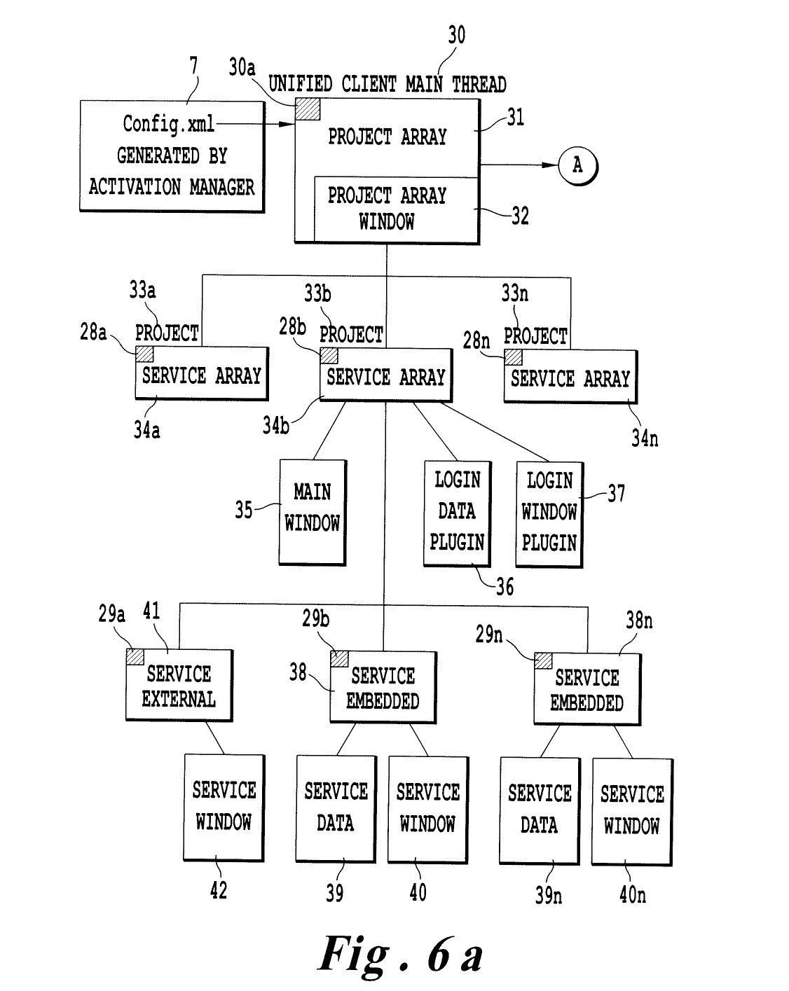

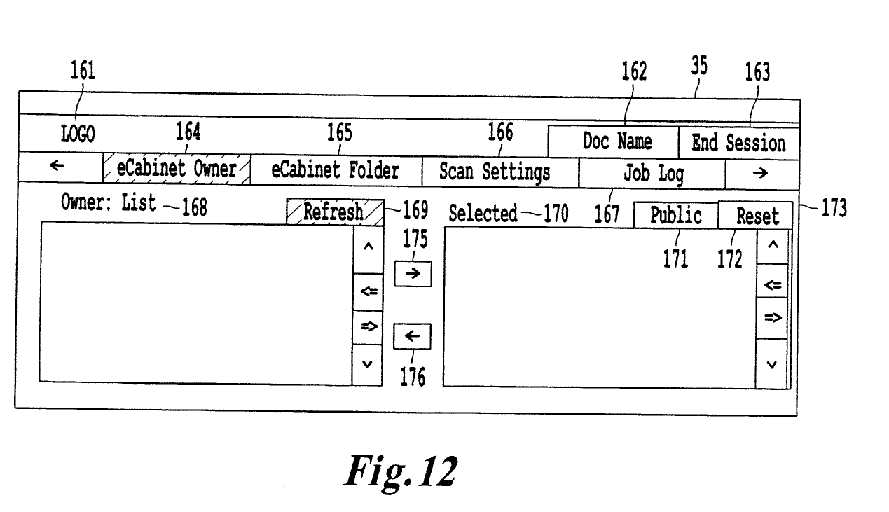

FIG. 4 shows an example of an internal structure of an embedded function 8 according to one embodiment of the present invention. For example, the embedded function 8 may include a single service window 10a or may also include a number of service windows such as 10a . . . 10n. Each service window 10a . . . n is a user interface that enables the user to interface with the service that corresponds to the service window 10a . . . n. The service window 10a . . . n also includes a corresponding activation reading part 15a . . . n. The activation reading part 15a . . . n is the first function performed when a service window 10a . . . n is executed and checks to see if the service window is active before any other functions are performed. Further explanation of the service window 10a . . . n will be discussed below with respect to FIGS. 12-16. The embedded function 8 may also include a single service data 11a or a number of service data elements 11a . . . n. The service data elements 11a . . . n also include an activation reading part 16a . . . n. As noted above with regard to the service window activation reading part 15a . . . n, the activation reading part 15a . . . n ensures that the service data elements are activated. Each service window 10a . . . n has corresponding service data 11a . . . n. In addition, the activation reading part of the service window 15a . . . n corresponds to the activation reading part 16a . . . n of the service data 11a . . . n. The service data 11a . . . n generally includes service name, service id, configuration data corresponding to the service window 10a . . . n, default service window data and run time data entered by users through service window 10a . . . n.

The embedded function 8 also includes a service data handler 12 and optionally may include a login window 13 and login data 14, in other words, an authentication user interface. The service data handler 12 is the portion of the unified client application that uploads data from the MFP to a receiving device. Included in the service data handler 12 is an activation reading part 17. The activation reading part 17 checks the activation information in the config.xml 7 file to ensure that the service data handler 12 is activated before any corresponding functions of the service data handler 12 are preformed. In each embedded function 8, there may be multiple service windows 10a . . . n and service data elements 11a . . . n. However, according to one preferred embodiment, there is only one service data handler 12. Other embodiments may have more than one service data handler 12.

FIG. 5 depicts an example of the Document Mall embedded function 8a. The Document Mall service can be installed on the core application 6 as an embedded function 8. When the Document Mall embedded function 8a is installed in the unified client application 5, the services provided by Document Mall are extended to the MFP in which the unified client application 5 is installed. The Document Mall embedded function 8a preferably includes the optional login window 23 and login data 24. These options allow user names, passwords and accounts to be input and utilized by the embedded function 8a, allowing the embedded function 8a to restrict unauthorized users from use of the embedded function 8a.

The Document Mall embedded function 8a further includes several different service windows and service data. For example, in the Document Mall embedded function 8b, an e-mail service window 20a and a folder service window 20b are included. The email service window 20a is a user interface enabling a user to enter a Document Mall stored email address as a scan destination, while the folder service window 20b is a user interface that enables a user to select a Document Mall folder as the scan destination. Further, an e-mail service data 21a and folder service data 21b are also included. The e-mail service data 21a and the folder service data 21b correspond to the data generated by the e-mail service window 20a and the folder service window 20b, respectively. Both the service windows 20a and 20b and the service data elements 21a and 21b include activation reading parts 25a . . . b and 26a . . . b. The activation reading parts are the first functions performed by the service window/data element pairs and are used to ensure that the corresponding service window/data is activated and able to perform a function. The Document Mall embedded function 8b also includes a service data handler 22. In the example of the Document Mall 8a the service data handler 22 is used as an upload handler that merges both the e-mail service data 21a and the folder service data 21b into one upload.xml file, and sends the upload file to a Document Mall server through an https post command, for example. Other uses for the service data handler 22 not mentioned in this example are also possible. The service data handler 22 also includes an activation reading part 27. The activation reading part 27 allows the service data handler 22 to ensure activation before performing any functions.

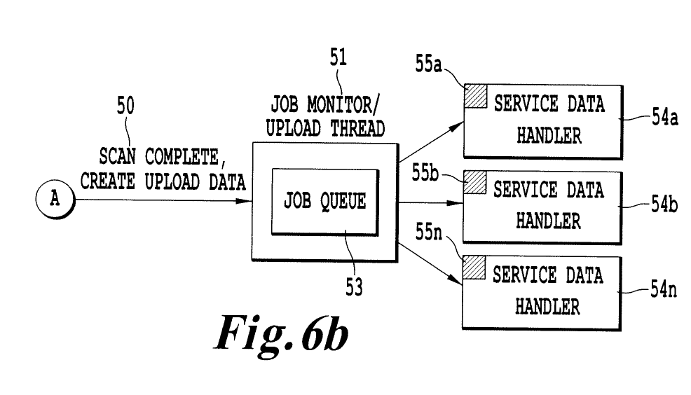

FIG. 6a shows the unified client software architecture structure. The unified client application 5, shown in FIGS. 2 and 3, is launched by a unified client main thread 30. In FIG. 6a, the unified client main thread 30 is shown as including an activation reading part 30a, a project array 31 and a project array window 32. The main thread 30 initializes the core application 6 and uses the activation reading part 30a to read the config.xml file 7 in order to create the project array 31 based on the activation information found in the config.xml file 7. The config.xml file 7 includes activation information regarding several projects 33a . . . n, each project 33a . . . n corresponding to at least one embedded function 8, one external function or a set including embedded and external functions.

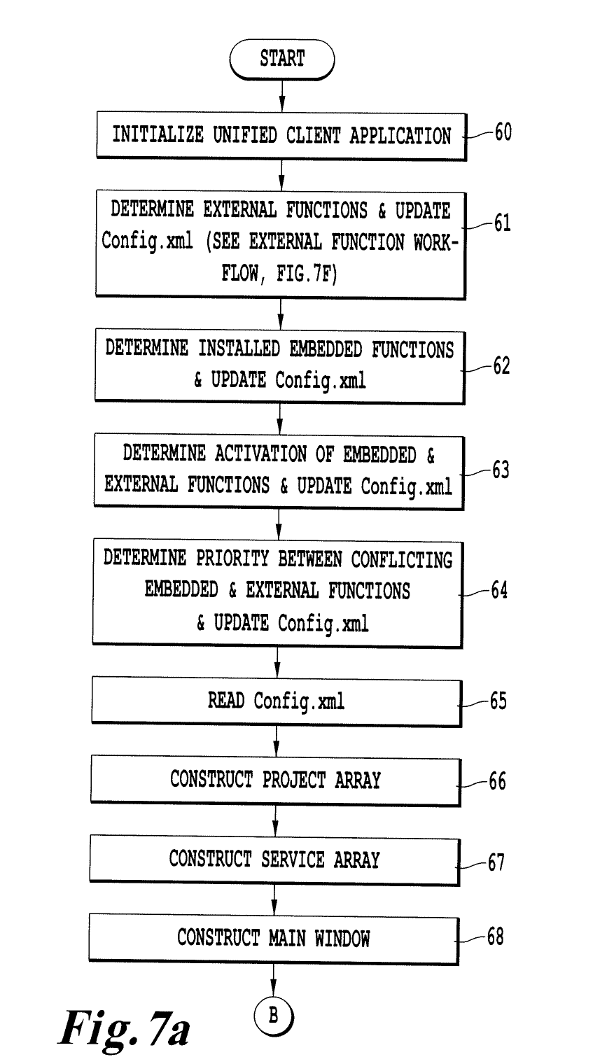

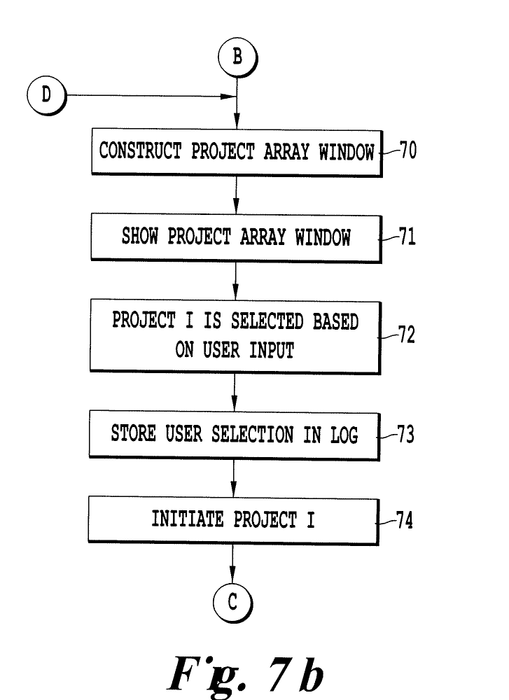

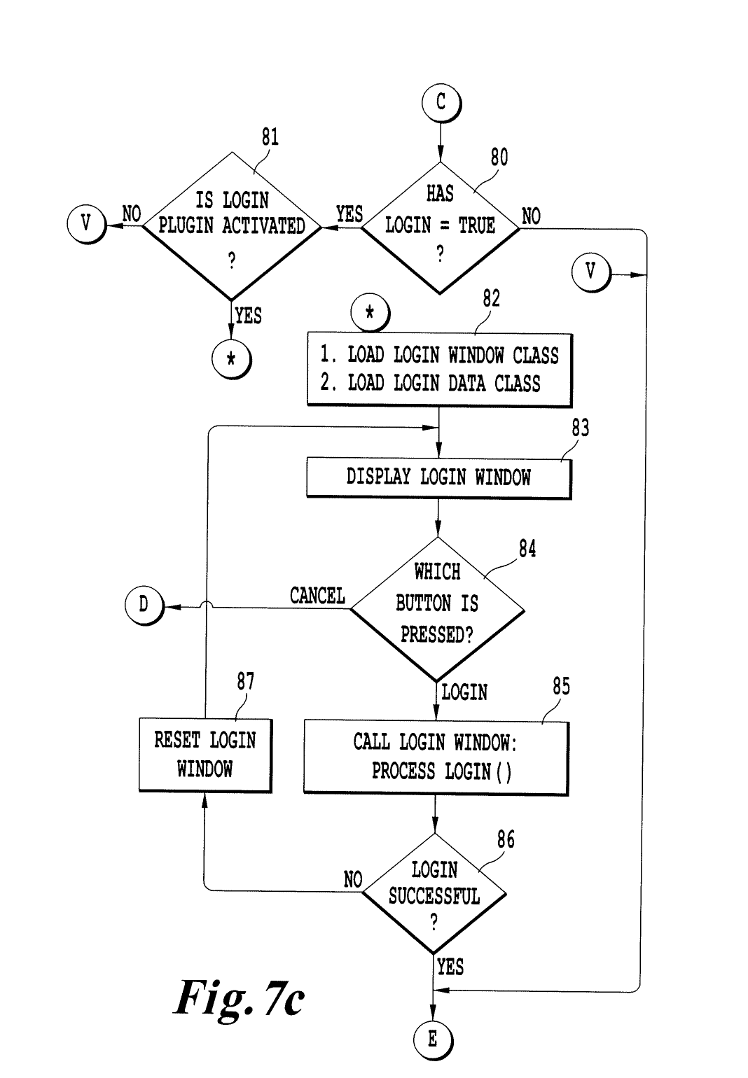

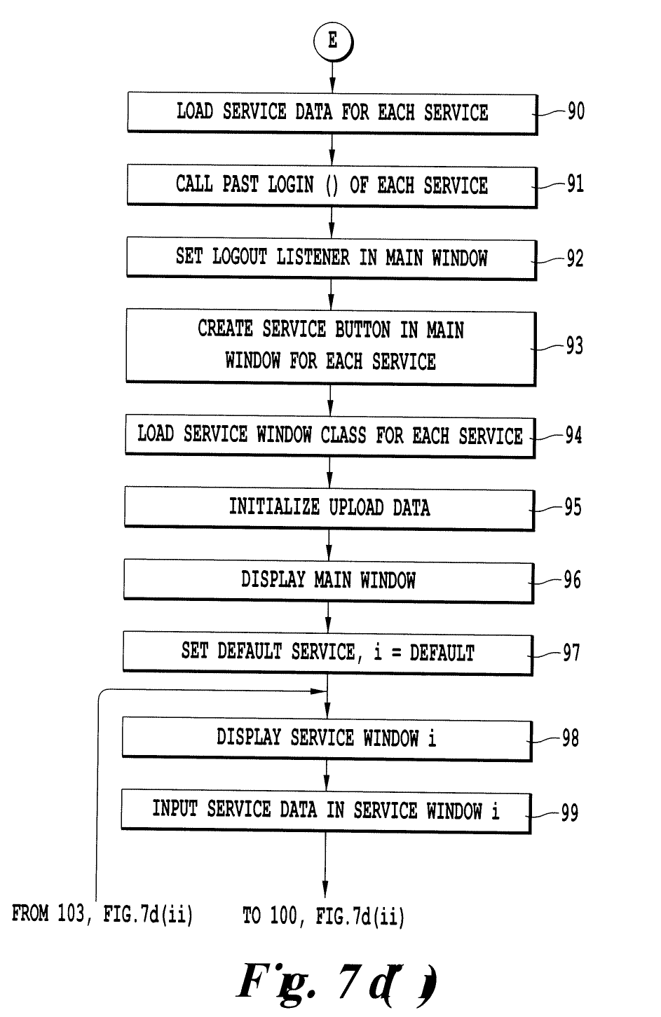

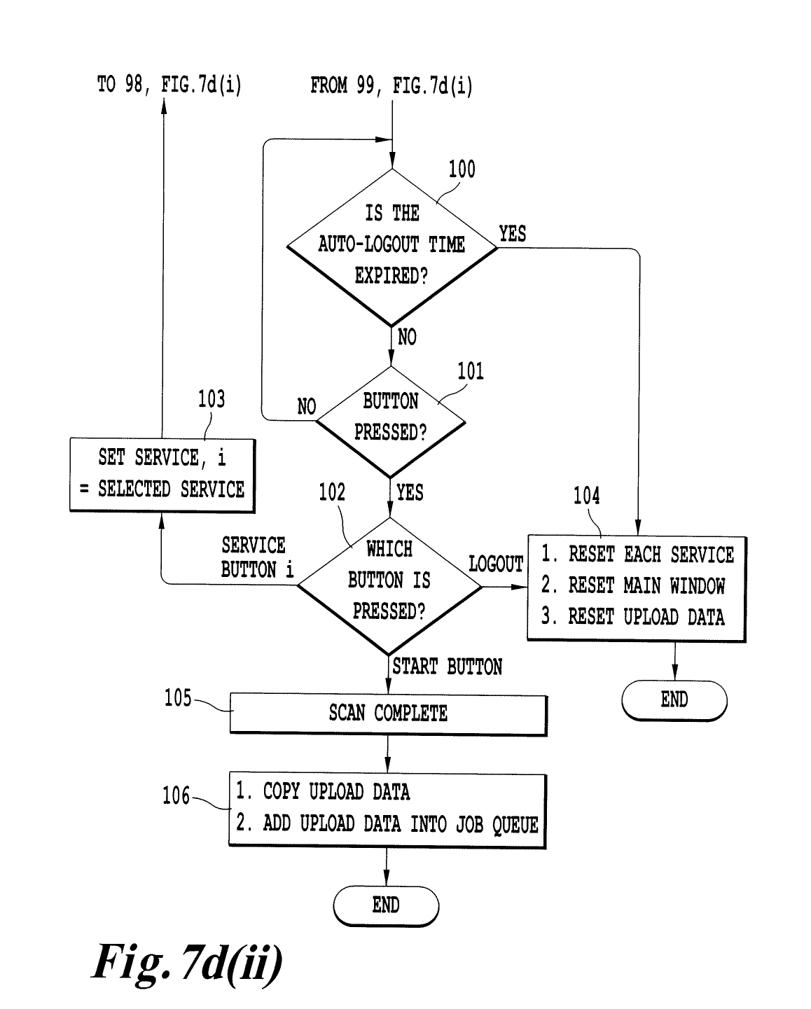

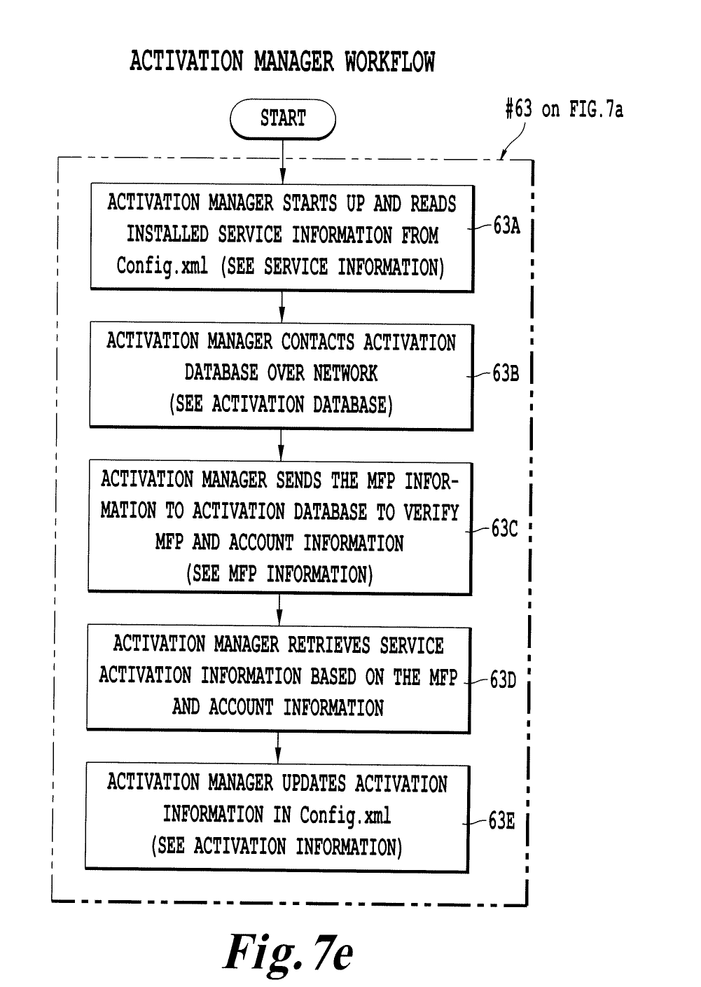

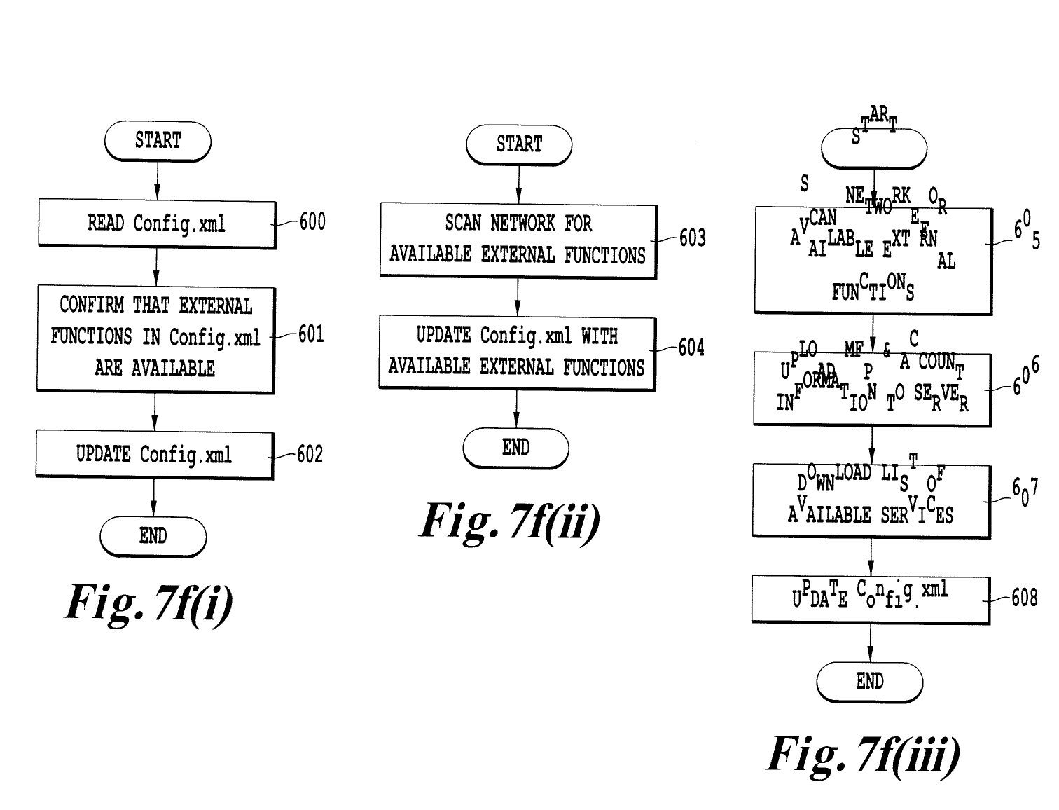

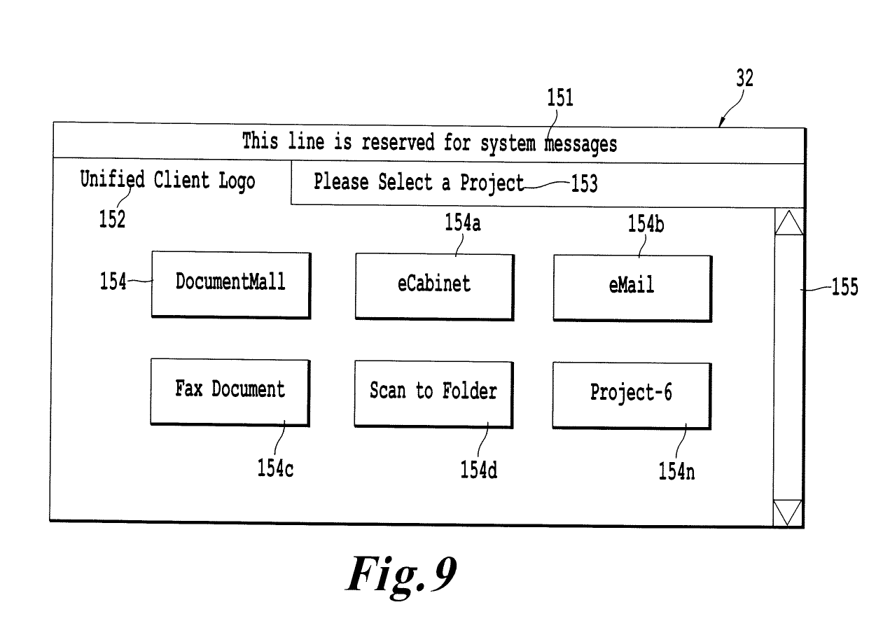

The project array 31 is a list of projects that are found to be active in the unified client application. The project array 31 is constructed by reading <project> tags included in the config.xml file 7. Further, the main thread 30 creates service arrays 34a . . . n for each project 33a . . . n by reading <service> tags and activation information included in the config.xml file 7. The service array is a list of the activated services installed under a respective project. The main thread 30 also displays the project array window 32. The project array window 32 is the first screen displayed when using or executing the unified client application 6. However, according to one embodiment of the invention, if only one project 33b is installed on the system, the project array window 32 will be bypassed. The project array window 32 displays project buttons for the user to select. When a project button is selected, the corresponding project 33a . . . n is invoked. It should also be noted that the project array window 32 may or may not display un-activated projects depending on the activation information found in the config.xml file 7. For example, in one configuration if no function is found to be activated by the main thread 30 for a project 33a . . . n, a project 33a . . . n may not be created for the function making it seem to the user as if the project does not physically exist on the MFP. In contrast, in another configuration if a function is found not to be activated, the main thread 30 may create a project 33a . . . n corresponding to the function. However, when the user attempts to execute the project 33a . . . n via the project array window 32 instead of loading the corresponding main window 35 the project 33a . . . n, the system will give the user the ability to activate the project 33a . . . n. Additionally, the system may give the user the ability to see a demonstration of the project 33a . . . n or use the project for a limited time. A more detailed discussion of the activation process can be found below with reference to FIG. 7E. The project array window 32 will be discussed in further detail below with respect to FIG. 9.

Several projects 33a . . . n are shown in FIG. 6a connected to the project array 31. Each project 33a . . . n includes an activation reading part 28a. The activation reading part 28a determines how the project 33a . . . n will be executed and which services 38a . . . n are included in a service array 34a . . . n. Each project 33a . . . n can manage a login/logout process of the project 33a . . . n through a corresponding login data 36 and login window 37. For example, if authentication is needed in the project 33a . . . n, a login window 37 can be used to display a login window which will be displayed before the user can begin accessing the project 33a . . . n. Once the login/logout button is pressed, a corresponding login and logout handler used by login data 36 will be called.

Further, the project 33a . . . n can control the post login process. For example, each service 38a . . . n can define its own post login process for its service window displayed by the service window 40a . . . n. When the authentication succeeds, the post login process of each service 38a . . . n will be called sequentially.

The login window displayed by the login window 37 described above, is an example of an authentication user interface (“UI”) display. The login window, displayed by the login window 37, interfaces with the login data which is included in the login data 36 and includes an authentication process definition. Additionally, the login window used by the login window 37 can be implemented to request additional authentication information. As one example, for the Document Mall embedded function 8a, the Document Mall login window 23 may be implemented to include a place for users to enter account information. Other information may be utilized by the login window 37. Additionally, the login data can be accessed by each service window 40a . . . n and service data handler 12. Further, each project 33a . . . n includes a main window 35 and a service array 34a . . . n.

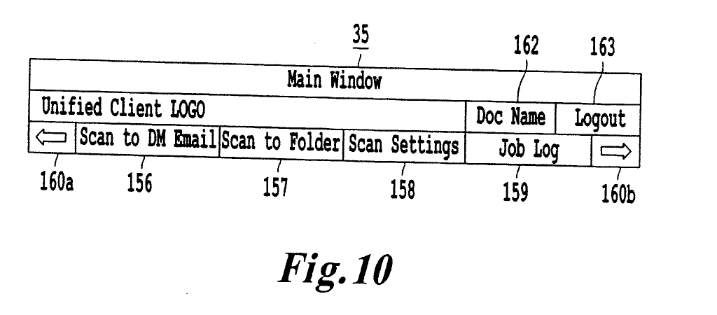

In FIG. 6a, a main window 35 is associated with the project 33b. Although the main window 35 is only illustrated under project 33b, each project 33a . . . n may be implemented to include a main window. The main window 35 is used for service management for each service 38a . . . n which corresponds to a button, the button being a user selectable link to a service window, included in the main window 35. For example, in the Document Mall embedded function 8a example, the main window 35 includes buttons for scanned setting handling, document name input and login button handling. Another example of the main window 35 is discussed below with respect to FIG. 10.

Included in each project 33a . . . n is a service array 34a . . . n. Each service array 34a . . . n includes a list of the activated services 38a . . . n. A service 38a . . . n is a function operable on the MFP. A project 33a . . . n may include a combination of embedded functions and external functions. A project 33a . . . n may also include only embedded functions or only external functions. In the case that a project includes both embedded and external functions and the functions conflict, such as both the external and embedded functions perform the same operation, priority information found in the config.xml file 7 is used to determine whether the embedded or external function is called when the service is selected in the main window 35. The present invention also includes the feature that if, for example, an external function has priority but the external function is unreachable due to a network problem the embedded function can seamlessly step in for the unavailable external function a will perform the function.

Each service 38a . . . n corresponding to an embedded function includes an activation reading part 29a . . . n, a service window 40a . . . n and service data 39a . . . n. The activation reading part 29a . . . n is the first operation activated by a service 38a . . . n and determines if the service is activated. A service window included in the embedded function 40a . . . n displays a service window user interface. Further, the service window 40a . . . n performs the post-login process or gets and sets default values in the service data 39a . . . n. For example, in the post-login process of the Document Mall embedded function 8a example, a Document Mall folder service downloads the user's folder list and sets the user's folder as the default folder destination. The service window 40a . . . n also performs interactive operations with the user to interact and update the service data in the service data 39a . . . n. The service window 40a . . . n is an abstract class and, as such, certain behaviors of the service window 40a . . . n are predefined in the code. However, a developer is able to add features to, or extend the service window depending on the needs of the developer. For example, in the Document Mall embedded function 8a example, a Document Mall e-mail service window supports both e-mail address search using the Document Mall service, and manual e-mail address entry.

The service data 39a . . . n is updated by the service window 40a . . . n based on user operations. Further, the service data 39a . . . n is accessed by an activated service data handler 12 when upload operations are performed. For example, if activated, the sending of e-mails or uploading to network folders may be performed by the service data handler 12 as is done in the Document Mall embedded function example 8a. As with the service window 40a . . . n, the service data 39a . . . n is an abstract class which can be updated or extended by developers to create further service related data. For example, in the Document Mall embedded function 8a example, the Document Mall e-mail service sends an e-mail based on the e-mail destination address that is saved in the service data included in the service data 39a . . . n.

Each service 41 corresponding to an external function also includes an activation reading part 29a . . . n, however there is no locally stored service data and the service window 42 only acts as a display interface for sending information to the external server corresponding to the external service.

Thus, the unified client main thread 30 includes a project array 31 which lists several projects 33a . . . n which may or may not include embedded or external functions, each project including the service array 34a . . . n which lists several services 38a . . . n corresponding to functions which may or may not be activated. As discussed above different embodiments of the present invention handle the inclusion of activated and non-activated projects and services in the corresponding project or service array. In one embodiment, only activated projects and services are included in the corresponding project and service arrays. In another embodiment the un-activated projects and services are included in the corresponding project and service arrays, when a user attempts to utilize the functionality of the inactivated projects and services the user is given the ability to buy or activate the service. Further detail regarding this feature will be discussed below with regard to the activation manager. The projects 33a . . . n found in the project array are displayed on a project array window 32 and each project includes a main window 35, and optionally a login window which is displayed before the main window 35, the login window could alternatively be displayed simultaneously with the main window 35. Further, each service 38a . . . n includes a service window included in the service window 40a . . . n.

It should also be noted that multiple functions can be associated with a single project 33a . . . n. For example, if the eCabinet Email function and the eCabinet Folder are included in a single project 33a . . . n, users will see links to both eCabinet Email and eCabinet Folder service windows 40a . . . n in main window 35. If a user enters all necessary information in corresponding service windows 40a . . . n, one scan job can be delivered using both the eCabinet Folder and eCabinet Email operations.

Turning now to FIG. 6b, this figure connects to FIG. 6a by symbol connector A. Once a scan by the MFP is completed, upload data 50 is created. The upload data 50 includes a document name, scan data, login data and service data, for example. The upload data 50 can also include any other information that can be uploaded by a service data handler 54a . . . n to a reception device. The service data handler 54a . . . n includes an activation reading part 55a . . . n and performs upload of data from the MFP, each service data handler being related to a project 33a . . . n. An upload thread/job monitor 51 includes a job queue 53. The upload thread/job monitor 51 is a background process that monitors the job queue 53 and processes the jobs when they become available. The upload thread/job monitor 51 is connected to the service data handler 54a . . . n. When a scan completes, the main thread 30 posts its final upload data 50 and adds it to the job queue 53.

For each job, the upload thread/job monitor 51 groups upload data 50 based on the corresponding service data handler 54a . . . n and invokes the corresponding service data handler 54a . . . n to process the upload data 50. For example, in the Document Mall embedded function 8a example, the upload thread/job monitor 51 passes generic data such as scan or image file related information, login data e-mail service data and folder service data to the Document Mall service data handler 54a . . . n to be processed. Once the upload thread/job monitor 51 has completed the above steps, the final steps are to get a job upload status and update a job log. The job upload status is the status of the upload by the service data handler 54a . . . n and the job log is the list of jobs processed by the upload thread/job monitor 51.

As described above, the service data handler 54a . . . n performs the upload of the upload data 50. However, the service data handler 54a . . . n will only perform its function if activation is first confirmed by the activation reading part 55a . . . n. For example, in the Document Mall embedded function 8a example, the activation reading part 55a . . . n will access the config.xml 7 to confirm that the service data handler 54a . . . n is activated. If activation is confirmed, then the service data handler 54a . . . n receives generic data, login data e-mail service data such as e-mail destinations and folder service data such as folder destinations. Finally the service data handler 54a . . . n composes the received upload data 50 into an upload.xml file and uploads the xml file to a Document Mall server designated in the config.xml file 7 via a http post process. Finally the service data handler 54a . . . n reports the upload status to the job monitor for job logging.

Any processes descriptions or blocks in flowcharts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

FIGS. 7A-7F show a flowchart of the unified client main thread 30. After starting in FIG. 7A, the unified client application 5 is initialized in step 60. The unified client application 5 is initialized by first initializing the core application 6. Next in step 61, the external functions are determined and the config.xml file 7 is updated. Further detail regarding the external functions determining process is found in FIG. 7F. In step 62, the installed embedded functions are determined and the config.xml file 7 is updated. It should be noted that the config.xml is updated each time a new function is installed on the MFP

Next in step 63, the activation manager 6b determines activation status of each external and internal function found in the config.xml file located on the MFP, further detail of this process is found in FIG. 7E.

In step 64, priority is determined between two conflicting external and embedded functions. The process for determining priority is based on information received by the activation manager.

The flow then moves onto step 65 where the config.xml file 7 is read. The config.xml file 7 includes settings for the core application 6 and for the functions which are operable on the MFP via the host or core application 6. A project array 31 is then constructed in step 66 based on the functions determined in steps 61 and 62 above. Next in step 67, the service array 34a . . . n is constructed for each project 33a . . . n. Further a main window 35 is constructed in step 68. FIG. 10, discussed in more detail below, shows an example of the main window 35. Flow then proceeds to process B in FIG. 7B.

In FIG. 7B, the project array window 32 is created in step 70 using the project array. The project array window 32 will only display projects that are activated or are available for activation by the user utilizing the MFP. Thus if the user utilizing the MFP does not have the authority to activate new projects, then only the previously activated projects will be available for selection. The project array window 32 is then displayed in step 71 and in step 72 a project is selected based on manual user input.

Once the project is selected by step 73, the flow then proceeds to step 73 where the user selection is stored in a log file. It should be noted that the present invention allows all user access and transactions within the MFP to be tracked and recorded. The log file can then be transmitted over the network to a central repository for billing uses, audit reporting or other purposes. It should also be noted that the log file stores use access and use information to be stored for both embedded and external functions accessed via the MFP.

When step 73 is accomplished, the system flow proceeds to step 74 where the selected project is initialized. From step 74 of FIG. 7b, flow proceeds to process C of FIG. 7C.

Turning now to FIG. 7C, step 80 determines if the initialized project includes a login window 37. If no login window 37 is installed, flow proceeds to process E of FIG. 7D. If the project includes a login window 37, then the flow proceeds to step 81 where it is determined if the login is activated. If the login is not activated, flow proceeds to process E of FIG. 7D. If the login is activated then flow proceeds to step 82 where both the login window class and the login data class are loaded.

Once the class files have been loaded, the login window is displayed in step 83. The login window includes both a login button and a cancel button. Depending on which button is determined to have been pressed in step 84, the flow proceeds differently. When the login button is pressed, the flow proceeds to step 85 in which the process login function of the login window 37 is called. However, if the cancel button is pressed in step 84, the flow proceeds to process D in FIG. 7B. Process D returns the flow to step 70.

If the login button is pressed in step 84 the login function of the login window 37 is called in step 85. Step 86 checks to see if the login was successful. If the login was not successful, the flow proceeds to step 87 to reset the login window and then returns to step 83. If the login was successful, then the flow proceeds to process E in FIG. 7D.

Thus FIG. 7C includes the general procedure of completing authentication if the login window 37 is installed in the selected project 33a . . . n. If no login window 37 is installed or the window 37 is not activated, then the entire login process is skipped.

Turning now to FIG. 7D(i), in step 90, service data for each service is loaded. Once the service data is loaded, the flow proceeds to step 91 where the post-login function of each service is called. In step 92, the logout listener is set in the main window 35. Additionally, in step 93 a service button for each service 38a . . . n is created in the main window 35. The service window class for each service is then loaded in step 94 and the upload data 50 is initialized or created in step 95.

Once the upload data 50 is initialized in step 95, the main window 35 is displayed to the user in step 96. The default service is then selected in step 97. It should be noted that the default service will always be an activated service. Then the service window corresponding to the selected service is displayed in step 98. In step 99 service data is input in the service window displayed in step 98. The flow then proceeds to step 100 in FIG. 7D(ii) which checks if the auto-logout time has expired. The auto-logout feature forces the flow to proceed to the logout step 104 if no user activity is detected for a predetermined period of time. If the auto-logout time is determined not to have expired in step 100, the flow proceeds to step 101 which determines if a button was pressed. If a button was pressed, the flow proceeds to step 102, if not the flow returns to step 100. Step 102 determined which button was pressed. If one of the service buttons was pressed, then the flow proceeds to step 103 where the selected service is set. The flow then returns to step 98 in FIG. 7D(i) where the newly selected service window is displayed. If in step 102 the logout button is pressed the flow proceeds to step 104 where each service is reset, the main window 35 is reset and the upload data is reset.

If the MFP “start button” is pressed by the user in step 102 the flow proceeds to step 105. In step 105 the scan is completed. The flow then proceeds to step 106 where the upload data 50 is copied and added to the job queue 53.

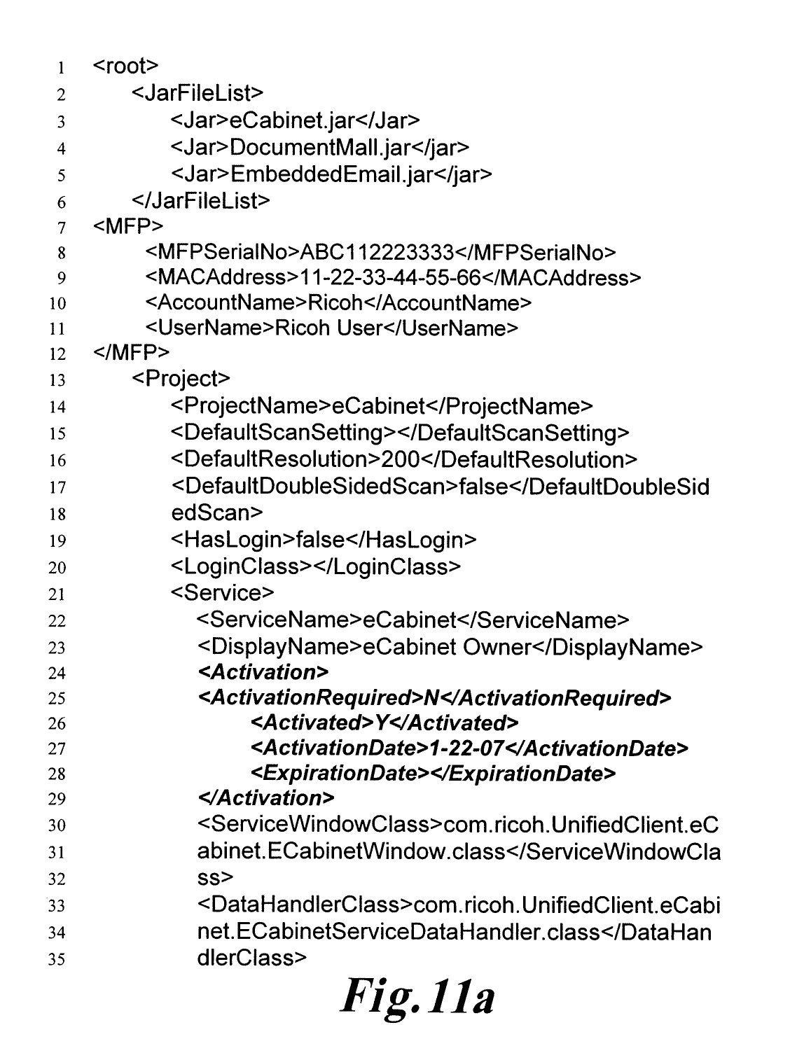

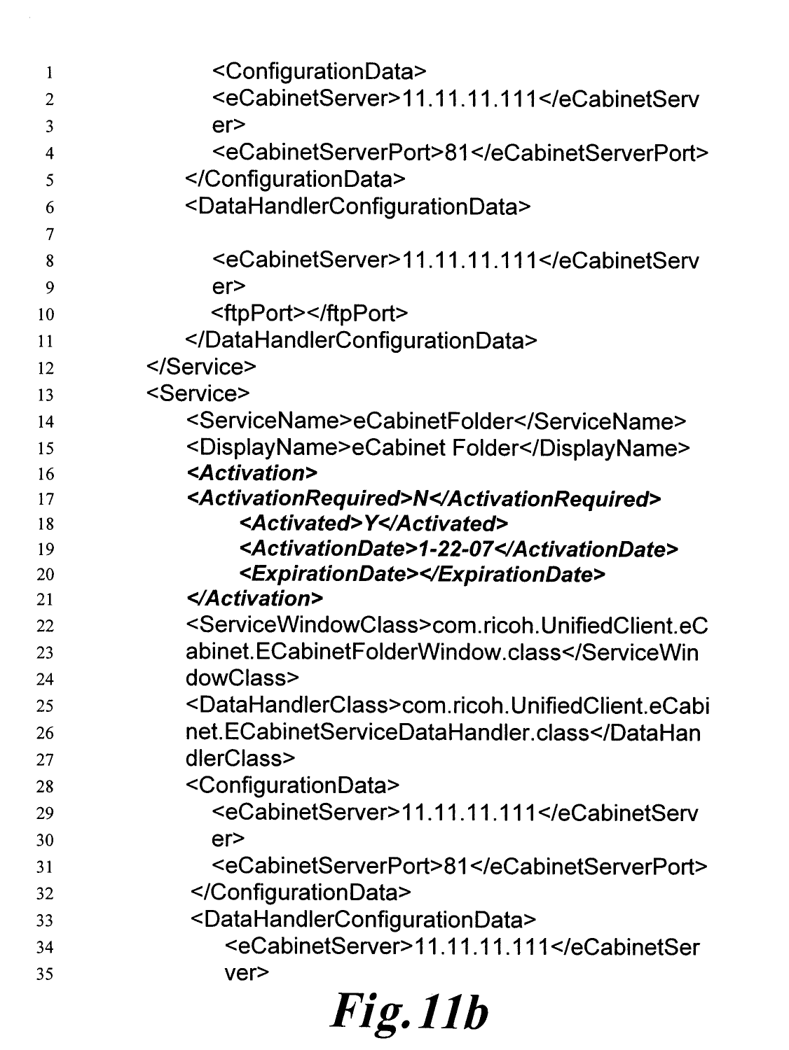

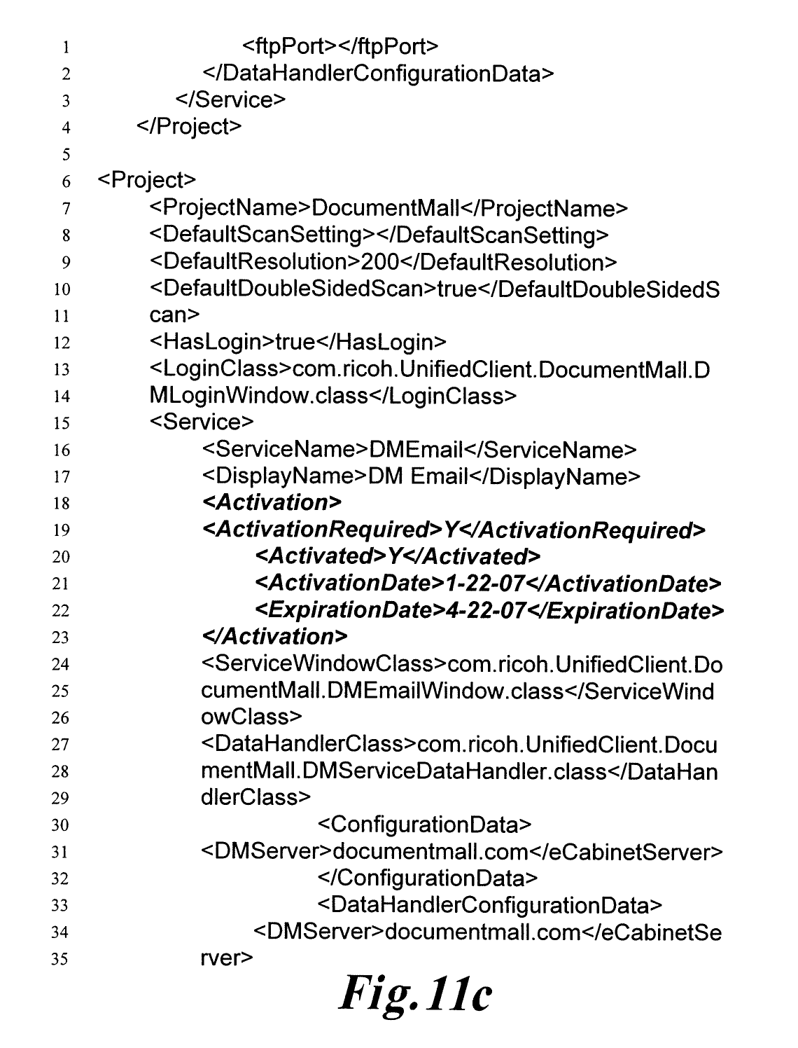

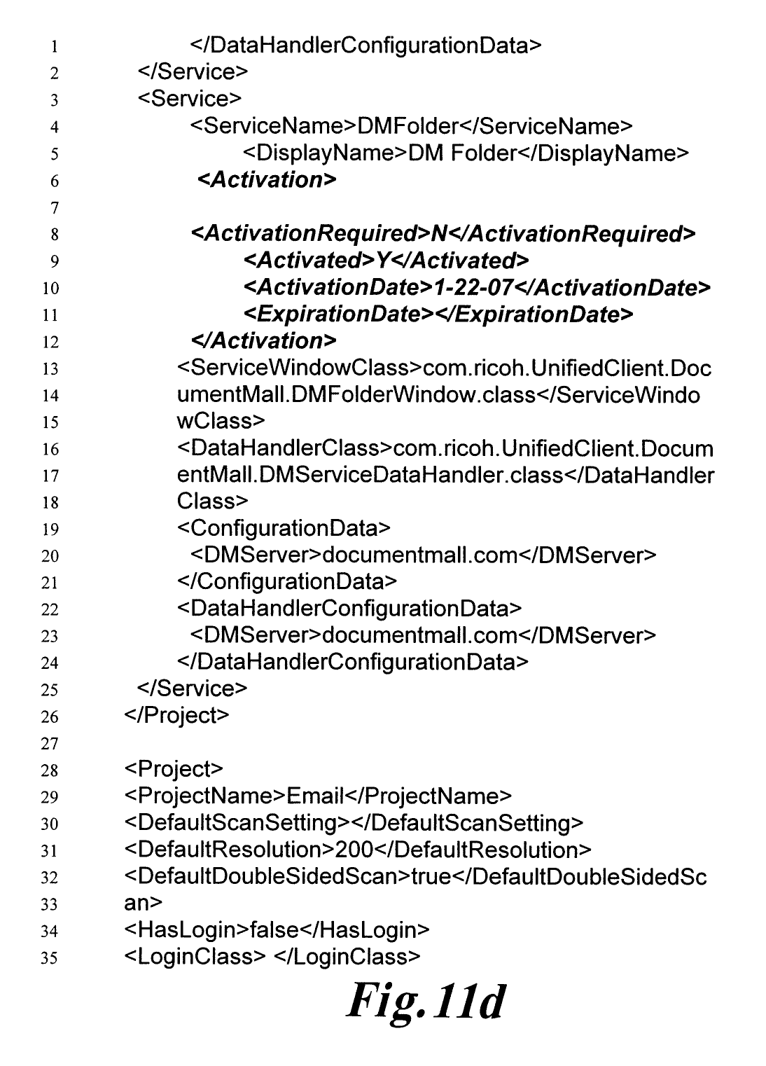

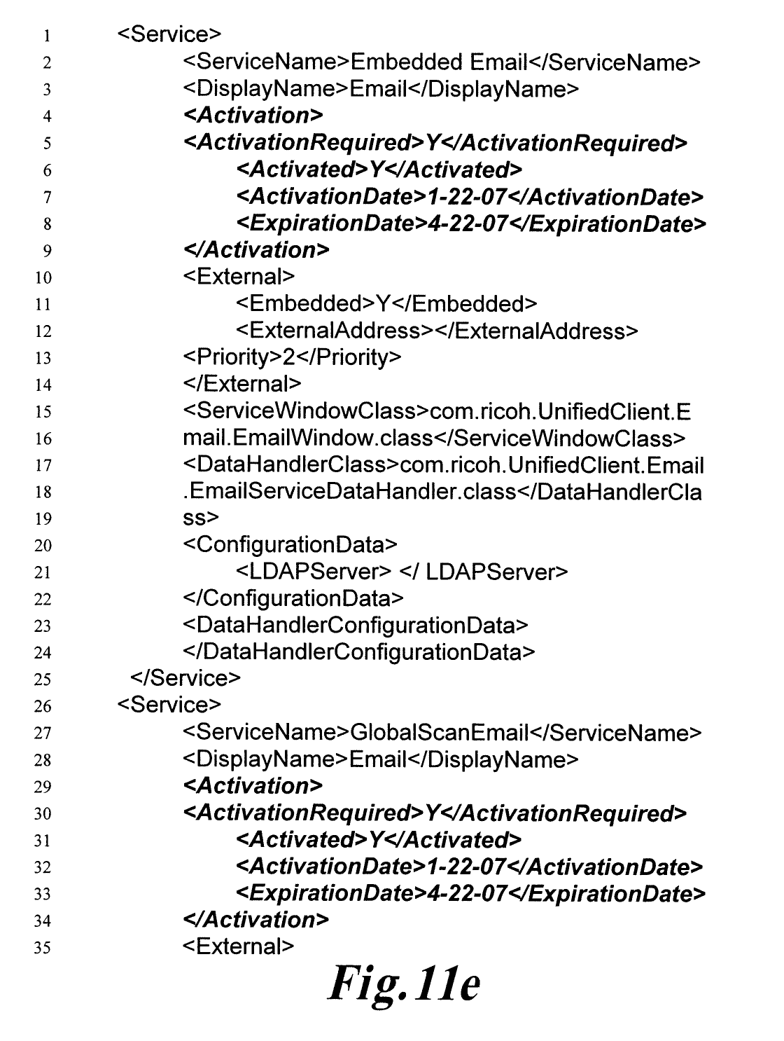

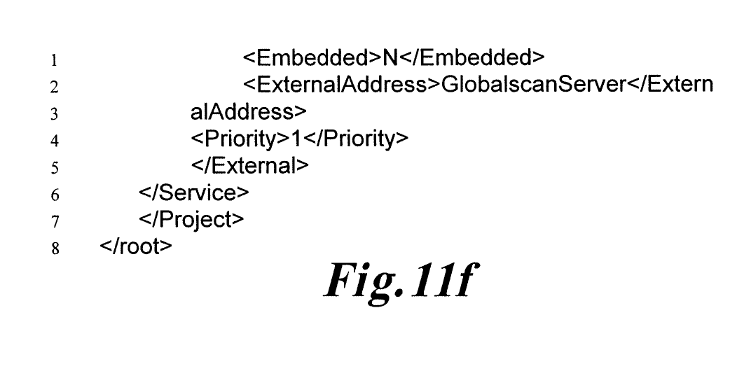

FIG. 7E shows a more detailed description of the activation manager 6a workflow. Specifically, FIG. 7E shows details of the process of step 63 shown in FIG. 7A. Step 63 is made up of five steps 63A-E. In step 63A the activation manager 6a starts up and reads the previously installed config.xml file 7. Included in the config.xml file 7 is MFP information, further discussion of the contents of the config.xml file 7 can be found below with regard to FIGS. 11A-11E.

The activation manager then contacts an Activation Database over a network in step 63B and sends information regarding the MFP to the Activation Database to verify the MFP and account information in step 63C. In step 63D, the activation manager 6a retrieves activation information and priority information regarding the priority between conflicting external and embedded functions from the Activation Database based on the sent MFP information. The activation manager 6A then updates the activation information in the config.xml file 7 based on the received information in 63E.

In the present embodiment, the activation manager updates the config.xml file 7 by contacting an activation database. In an alternate embodiment, the activation information could be retrieved from another MFP in the network that had contacted the activation database at a previous time.

FIGS. 7F(i), 7F(ii) and 7F(iii) show a more detailed description of the external functions determination workflow. Specifically, FIGS. 7F(i), 7F(ii) and 7F(iii) show three embodiments of the internal process of step 61 shown in FIG. 7A.

The first embodiment shown in FIG. 7F(i) comprises steps 600-602. In step 600, the flow reads the config.xml to identify any services that are indicated as corresponding to external functions. Then in step 601, using the information in the config.xml file 7 the availability of the external functions are confirmed. For example, if several globalscan functions were previously stored in the config.xml file 7 such as globalscan email or globalscan fax, the flow would then confirm that the globalscan server still exists and that the functions previously included in the config.xml file are still available. In step 602 the flow then updates the config.xml file 7 and indicates if the functions are not available.

Embodiments two and three relate to the situation in which the external functions available to the MFP are not known and are not previously stored in the config.xml of the MFP. Thus, the MFP has the ability to discover external functions based user input using a search mechanism or automatically as is described in embodiments two and three.

The second embodiment shown in FIG. 7F(ii) comprises steps 603 and 604. In step 603 the network is scanned using a discovery mechanism and available external functions are discovered. For example, referring back to FIG. 1, the branch office MFP 500 could discover the globalscan server 504 and connect to the server 504 and discover a number of services that are available on globalscan server 504.

Once available external functions are discovered in step 603 the config.xml file 7 is updated in step 604.

The third embodiment shown in FIG. 7F(iii) comprises steps 605-608. The third embodiment differs from the second embodiment in that the address of the server including the external functions is already known by the MFP. Thus, in step 605 the MFP connects to the external function server. In step 606 the MFP uploads MFP and account information to the external function server. This allows the external function server to confirm that the MFP has the authority to use the external functions provided by the server. In step 607 a list of available services is downloaded by the MFP and is used in step 608 to update the config.xml with available external functions.

However, it should be noted that even though in step 606 the MFP uploads information to the external function server the unified client platform uses a uniform security policy that allows the user to be authenticated for both embedded and external functions at the same time. Using the activation manager 6A this step is accomplished because although a function may be available to be accessed via the MFP the user may not have access to this function, thus the function is de-activated even if it is included in the config.xml file 7.

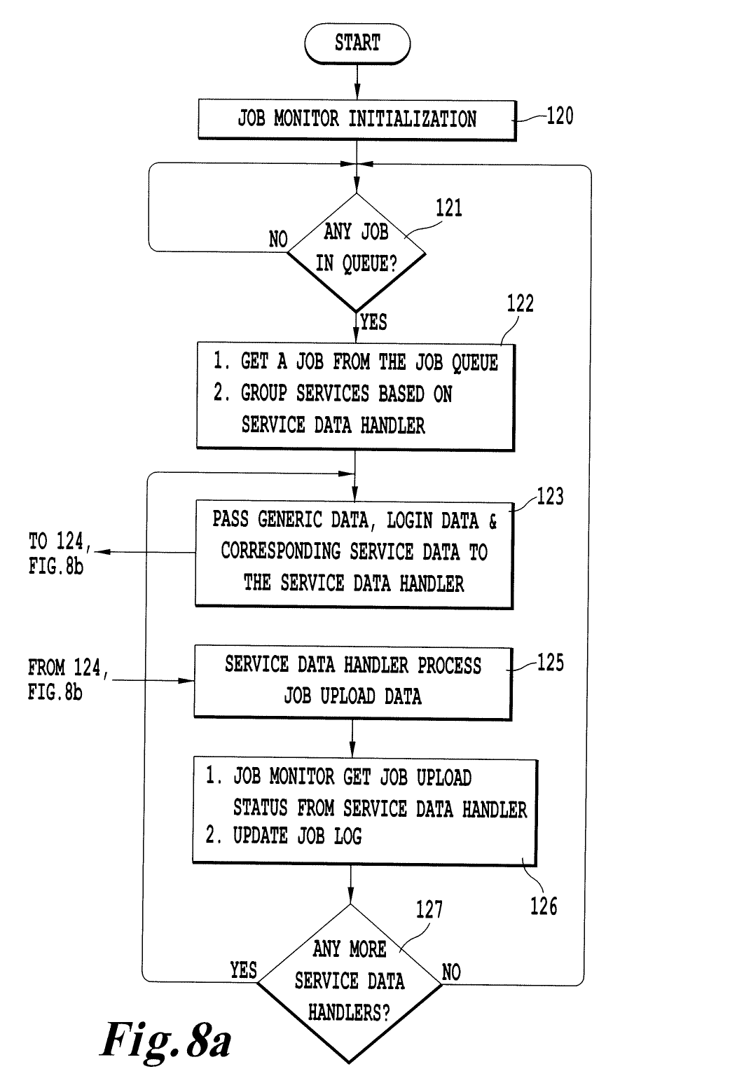

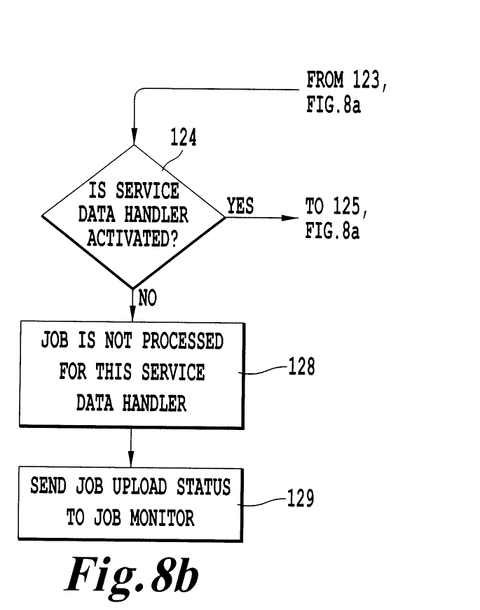

Turning now to FIGS. 8A and 8B, FIGS. 8A and 8B show a flowchart of the unified client upload thread 51. After starting, a job monitor initialization is performed in step 120. The system then checks if any jobs are in the job queue 53 in step 121. If no jobs are determined to exist in the job queue 53, flow proceeds back to the beginning of step 121. The system continues in this for a loop until a job is observed in the job queue 53.

When a job is determined to exist in the job queue 53 in step 121, flow proceeds to step 122 and gets the job from the job queue 53 and groups services included in the job based on the corresponding service data handler 54a . . . n. Next, the generic login data and corresponding service data is passed to the service data handler 54a . . . n in step 123. In step 124 it is determined if the service data handler 54a . . . n is activated. If the service data handler is not activated flow proceeds to step 128 where the job is not processed for the service data handler 54a . . . n. The flow then proceeds to step 129 where the job upload status is sent to the job monitor. Flow then proceeds to step 127.

If however in step 124 the service data handler 54a . . . n is activated, the service data handler 54a . . . n then processes the job upload data 50 in step 125.

Once the service data handler 54a . . . n has processed the job upload data 50, the job monitor 51 gets the job upload status from the service data handler 54a . . . n and updates the job log in step 126. Flow then proceeds to step 127 which checks to see if there are any more service data handlers 54a . . . n. If no service data handlers 54a . . . n remain for the job, then flow moves back to step 121 to check for new jobs in the queue. If more service data handlers 54a . . . n are included in 127, flow proceeds back to step 123 and processes steps 123-126 again. This loop continues until no service data handlers 54a . . . n remain for a job.

Thus the unified client upload thread includes two loops, the first checks for new jobs in the queue. The second loop occurs once a job is determined to exist, in the second loop, the system loops through checks to make sure all of the activated service data handlers 54a . . . n in a job have been processed.

Moving now to FIG. 9, there is shown an example of a project array window 32. The project array window 32 includes a line reserved for system messages 151. Also included is a unified client logo 152 and instructions to the user on how to use the project array window 153. The project array window 153 also includes several project buttons that are selectable by the user 154 and link the user to the main window 35 and default service window of the selected project 33a . . . n. Examples of such buttons are the Document Mall button 154, eCabinet button 154A, Email button 154B, Fax document button 154C, scan to folder 154D or other similar type projects buttons 154n. The scroll bar 155 allows a number of project buttons to be installed in the project array window 32. Thus the function of the project array window 35 is to allow a user to select which project 33a . . . n the user may like to use on the MFP.

FIG. 10 shows an example of a main window 35. The main window 35 includes the unified client logo 161 as well as the document name 162 and a logout button 163. As discussed earlier with respect to FIG. 7d, the logout button 163 allows the user to log out of the selected project and return to the project array window 32 described in FIG. 9. The main window 35 also includes a number of buttons 156 through 159 which correspond to a number of services or alternatively one service if only one function is associated with the project 33a . . . n. The buttons displayed in the main window 35 correspond to the project 33a . . . n which was selected in the project array window 32. For example, when the Document Mall project is selected 154 in the project array window 35, several Document Mall related buttons are available. For example, the button 156 allows the user to open a scan to a Document Mall e-mail service window. Item 157 allows the user to open a scan to a folder service window. Item 158 is a button that open up the scan settings service window. While item 159 allows the user to open up the job log service window. The invention is not limited to the number of buttons included in FIG. 10 or the services shown in FIG. 10. Additionally arrow buttons 160a and 160b allow the user scroll through a number of service buttons. Thus, any type of service button can be installed on the main window 35.

FIGS. 11A-11E show an example a config.xml file 7 according to one embodiment of the present invention. It should be noted that FIGS. 11A-11E are not intended to be a comprehensive example of how a config.xml file 7 may be designed, instead FIGS. 11A-11E include one way that a config.xml file 7 might be written for activation of a unified client application 5.

FIG. 11a begins the example of the config.xml file 7. In line 1 of FIG. 11A, the config.xml file 7 begins with the root tag. Under the root tag are the jar file list tags which include different jar files that are installed on the system. A jar file is a single file that includes several class files. The class files each include portions of code that, in the present example, correspond to different services 38a . . . n. In the present embodiment, the jar files listed in the config.xml file 7 correspond to embedded functions that are installed in the unified client application 5. In this example, the eCabinet jar file, the Document Mall jar file and the EmbeddedEmail.jar file are installed. The eCabinet jar file corresponds to the eCabinet embedded function 8b and the Document Mall jar file corresponds to the Document Mal embedded function 8a. The EmbeddedEmail jar file corresponds to the embedded email function. Each embedded function is included in a project 33a . . . n.

The MFP section starting on line 7 includes several tags which relate the MFP and the account associated with the MFP. On line 8 is found the MFPSerialNo tag which includes the MFP serial number. The MFP serial number is a unique number which identifies the hardware of the MFP. On line 9 is found the MACAddress tag which includes the MFP MAC Address. The MAC address is a unique network identification code that identifies the network interface of the MFP. On line 10 is found the AccountName tag which includes the account name to which the MFP is registered. In the present example the account name is Ricoh.

On line 11 the UserName tag is found which includes the username of the user currently logged into the MFP. It should be noted that in alternate embodiments no UserName tag is used. In addition, the ModelName tag not shown in FIG. 11A can be included in the MFP section. The ModelName tag identifies the model name of the MFP. Finally on line 12 the close MFP tag is found which identifies the end of the MFP section.

As noted above with regard to FIG. 7E, the portion of the config.xml file 7 enclosed in the MFP tags is part of the MFP information sent to the activation database. The MFP information is then used by the activation database to determine which services are activated. Thus the data in the MFPSerialNo, MACAddress and ServiceName tags can be used as a unique key.

In line 13, the project tag begins the project 33a . . . n and in line 14 the project name is designated, in this example the project name is described as eCabinet. The default scan setting, included in line 15, is empty in this example but could include a number of different settings. In line 16 the default resolution setting tag is included, in this example, the default resolution is set to 200, which corresponds to 200 dpi. In line 17 the default double side scan setting is included. In this example the default double side scan setting is set to false. This setting allows the user to set if the multi-function printer will scan both sides of the paper instead of just a single side.

In line 19 the login setting for the project is included. In this example, the eCabinet project does not have a login. However, this setting could also be set to true. In one embodiment of the config.xml file 7, if in line 19 the login setting is set to true, in line 20, a login class may be included. Other embodiments may not include the class file in this manner. In this example, no login class is included because the login setting in line 19 is set to false.

As discussed earlier, each project 33a . . . n includes a number of services 38a . . . n. In line 21, the service tag begins the section describing a service 38a . . . n. In line 22, the service's name is included and in line 23 the display name is also included. In this example, the service name is set to eCabinet and the display name is set to eCabinet Owner. The display name setting shows how the service is displayed in the service buttons in the main window 35.

Line 24 shows the Activation open tag. This tag begins the activation section of the service. Included in the activation section are several tags related to the activation of the service. The example shown in FIG. 11A is one way of including activation information in the config.xml 7 file, other ways are also possible. On line 25 the ActivationRequired tag is found. This tag includes a boolean indicator which denotes whether or not activation is required for the service in question. In the present example, shown on line 25, the ActivationRequired tag is listed as “Y”, however if the tag included a “N” or “F” indicator the service would always be available to be used on the MFP. The default value for this tag is “Y”.

The next tag in the activation tag section is the Activated tag which is found on line 26. As with the ActivationRequired tag noted above, the Activation tag includes a Boolean indicator. The Boolean indicator corresponds to whether or not the service in question is activated. If the indicator shows “N” or “F” then the service will not be available to the user of the MFP unless the user goes through an activation process. In the present example the Activated tag includes a “Y” indicator. When a “Y” indicator is found in the Activated tag, the ActivationDate and ExpirationDate tags found on lines 27 and 28 list the date that the service was activated and the expiration date of the activation, respectively. The ExpirationDate tag is useful in the case that the Activation Database is unable to be contacted. If the Activation Database is unreachable, the activation manager can compare the internal date stamp of the MFP with the information found in the ExpirationDate tag of the config.xml file 7 to ensure that the activation is still valid. Finally, the Activation close tag is found on line 29.

In should be noted that several different tags may be used in the Activation Section depending on the type of activation used. In the present example, time-based activation is used, however, when different types of activation are used different tags may be used in the activation section.

For each project a data handler is included and for each service corresponding to an embedded function a service window class file is included. In this example, in lines 30-32 the service window class file is listed. The service window class file includes all the code necessary to display the service window. In lines 33-35 the data handler class file is listed. This includes all the code necessary for the data handler in this project.

Beginning on line 1 of FIG. 11B, the configuration data for this service is included. In this example, on line 29 the eCabinet server address is listed as 11.11.11.111. The address 11.11.11.111 is an example of an address that may be used other addresses including IPv6 addresses or named addresses, such as domain names, can also be used. Further, the eCabinet server port is listed as port 81. Other port numbers could also be used in this example.

Beginning on line 6, the data handler configuration data is included. In this example, the data handler configuration data includes the eCabinet server address on lines 8-9 and the FTP port on line 10. If no FTP port is included in line 10 a default ftp port is used, such as 21. On line 11, the data handler configuration data tag is closed and on line 12 the service is closed. Thus the eCabinet service configuration in this example is described between lines 21 of FIG. 11A and line 12 of FIG. 11B.

On line 13 a second service included underneath the eCabinet project is described. Beginning on line 13, the service tag opens the service. The service name in this example is included on line 14 and is listed as eCabinet Folder. The display name included on line 15 is listed as eCabinet Folder.

Lines 16-21 show the Activation section for the eCabinetFolder service. As was described with regard to the eCabinet service above, the Activation section of the eCabinetFolder service includes open and close Activation tags, an ActivationRequired tag, an Activated tag, an ActivationDate tag and an ExpirationDate tag.

Additionally, as was the case in the eCabinet service described above, the eCabinet Folder service also includes a service window class shown on lines 22-24 and a data handler class included in lines 25-27. Also included in the eCabinet folder service are the eCabinet server address, on line 29, and the eCabinet server port included on line 31. Also in this example, the data handler configuration data tag area begins on line 33 and includes an eCabinet server address, on line 34, and a FTP port setting on line 1 of FIG. 11C. The Data handler configuration data tag area is closed on line 2, the service is closed on line 3 and the project is closed on line 4. Thus in this example, the eCabinet project includes two services, the eCabinet service and the eCabinet Folder service.

Line 6 continues the example of the config.xml file 7. On line 6 of FIG. 11C, a new project is opened with a project tag. The project name is described on line 7 as Document Mall. In this example, in line 8, the default scan setting tag is opened and closed denoting the default setting and, in line 9, the default resolution is set to 200. In line 10, the default double siding scan is set to true and in line 12 the login setting is set to true. As was noted in the discussion regarding eCabinet project above, because the login setting is set to true in line 12, in lines 13 and 14 the login class file is included. In contrast to the eCabinet project described above, in the Document Mall project example, the login class is included.

Beginning on line 15, the service tags included under the Document Mall project are described. The first service begins with a service tag, included on line 15. In line 16, the service name DMEmail is included and on line 17 the display name DM Email is also included.

Lines 18-23 show the Activation section for the DocumentMall Email service. As was described with regard to the other services described above, the Activation section of the DocumentMall Email service includes open and close Activation tags, an ActivationRequired tag, an Activated tag, an ActivationDate tag and an ExpirationDate tag.

The service window class is described at lines 24-26 and the data handler class is described in lines 27-29.

Beginning on line 30, the configuration data for the Document Mall email service is included. In this example, in line 31, the Document Mall server address is included as documentmall.com and in line 32 the configuration data tag is closed. In line 33 the data handler configuration data tag is opened. Within this tag, in lines 34-35, the Document Mall server address is included and on line 1 of FIG. 11D the data handler configuration data tag is closed. In line 2 the Document Mall Email service is closed.

Line 3 begins a second service under the Document Mall project with the service tag. On line 4 the service name of DMFolder is included and in line 5 the display name DM folder is also included. In lines 6-12 the activation portion of the service is included. In lines 13-15 the service window class is described and in lines 16-18 the data handler class is described. In line 19, the configuration data begins with the configuration data tag. In line 20, the Document Mall server address is included. In line 21 the configuration data is closed. Lines 22-24 show the data handler configuration data, with line 23 showing the Document Mall server address. In line 25, the close service tag closes the service. In line 26, the close project tag closes the Document Mall project.

Line 28 includes a project tag which begins a new project. Line 29 includes the project name which is Email. The default scan setting, included in line 30, is empty in this example. In line 31 the default resolution setting tag is included, in this example, the default resolution is set to 200, which corresponds to 200 dpi. In lines 32-33 the default double side scan setting is included. In this example, the default double side scan setting is set to false.

In lines 34-35 the login setting for the project is included. The haslogin setting is false and the loginclass tag is empty. The Email project shown in the present example has two services, the embedded email service found in lines 1-25 of FIG. 11E and the GlobalScanEmail service found in lines 26 to line 6 of FIG. 11F. Both services include an external tag section which is found in lines 10-14 for the embedded email and line 35 to line 5 of FIG. 11F for the GlobalScanEmail.

The external tag section includes Embedded, ExternalAddress and Priority tags. The Embedded tag is a Boolean value that describes how the service is performed using the MFP. If the Embedded tag is set to true, then the service corresponds to a function that is embedded or physically installed on the MFP. If the Embedded tag is set to F, then the service corresponds to an external function or a function in which the function is performed on an external server. For example, for the Email function described in lines 26 to line 6 of FIG. 11F, an image is scanned on the MFP locally but the email itself is created and the scanned image is converted into PDF on an external server. Thus, the function of creating the Email is performed externally from the MFP.

The ExternalAddress tag is empty when the Embedded tag is set to true. However, when the Embedded tag is set to F, then the ExternalAddress tag includes the network address of the server on which the external function corresponding to the service is located.

The Priority tag is used to determine the priority for two services in the same project which are conflicting. In the present example, the embedded email function and GlobalScanEmail function are conflicting because both services perform the same function in the same project. Thus, the External tag section includes a tag that allows the MFP to know which service has priority over the other or whether the user will be using the embedded or external email function by default when the Email function is selected. As described earlier, if the external function is determined to have priority, but the external function server is unavailable, the embedded function can be enabled as a failsafe. The user will thus suffer no disruption in MFP functionality even though the external service is unreachable.

The Email project is then closed on line 7 of FIG. 11F and in line 8, the close root tag closes the config.xml file 7.

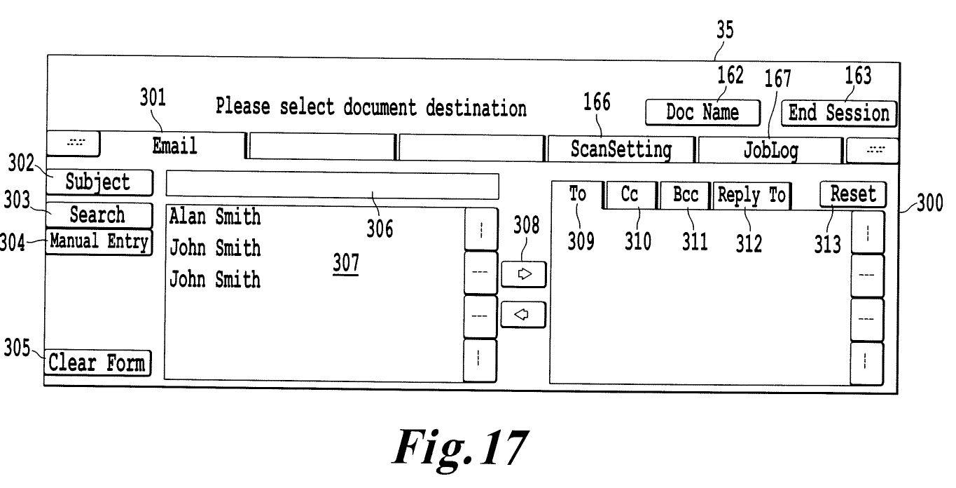

A functional example of the unified client application 5 installed on a multi-function printer will now be described in FIGS. 12-17. In FIGS. 12-16 of this example, the unified client application 5 is installed with the eCabinet embedded function 8b. In FIG. 17 the unified client application 5 also includes the Email external/embedded function. The unified client application 5 with an eCabinet embedded function 8b is developed using SDK/J and uses the CVM option on each MFP in which the unified client application 5 is installed. SDK/J is an embedded software architecture software development kit (“SDK”) which allows in house developers, independent software vendors and system integrators to deliver customized JAVA based solutions on MFPs. The CVM option is the java virtual machine that is able to be installed on the MFP. Other types of virtual machines and/or programming languages can be used to create embedded functions associated with the unified client application.

The example of the unified client application 5 with the eCabinet embedded function 8b uses 2 SDK/J type applications, the 2 SDK/J applications are, for example, one Java xlet application which implements major unified client functionalities and one servlet application which allows user to update the config.xml file 7 remotely via a web browser. Some of the services or functions that are supported by the unified client application 5 with the eCabinet embedded function 8b are: scan to eCabinet server, scan to eCabinet folder, scan settings and job log viewing. These services are represented as service buttons in the eCabinet project main window 35.

In FIG. 12, an example of a main window 35 and service window 173 is shown. The main window 35 and the eCabinet owner service window 173 are displayed. The main window 35 includes a logo 161 as well as the document name 162 and an end session or logout button 163. Further, several service buttons 164-167 are also included in the main window 35. In the eCabinet example, the first service button is the eCabinet owner button 164. In FIG. 12, this button is selected and as a result the corresponding eCabinet owner service window 173 is displayed. The left side of the eCabinet owner service window includes an order list window 168 and a refresh button 169. Further, on the left side of the eCabinet owner service window 173 there is a selected owner's window 170. Also included are a public 171 and reset button 172. The eCabinet owner button offers users the ability to select the eCabinet owner for use with the eCabinet Folder service and eCabinet Email service (not shown). The owner list is downloaded from the eCabinet server automatically and is displayed in the owner list window 168. Multiple owners can be selected if no eCabinet folder is selected in the eCabinet folder window 193. When an eCabinet folder is selected in eCabinet folder window 193, only a single owner selection is allowed. The owner list window 168 shows a list of the owners. The selected window 170 shows the destination owners. To add a destination owner, the user can highlight desired owners in the owner list window 168 and press the right arrow button 175. To delete a destination owner, the user can highlight the owner in the selected window 170 and press the left arrow 176. The refresh button 169, allows the user to download the owner list from the server again. The public button 171 allows the user to set the attribute of the scan document to public or private. The reset button 172 allows the user to remove all of the contents of the selected window.

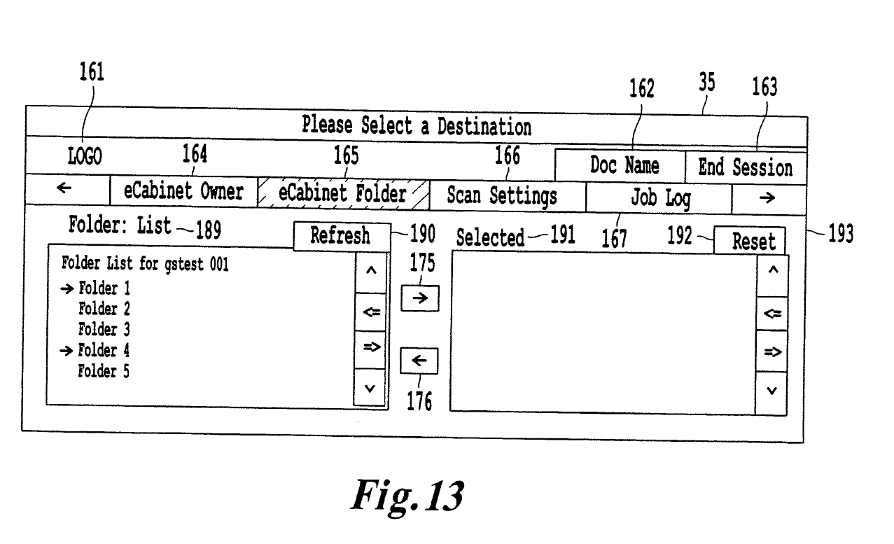

FIG. 13 shows an example of the main window 35 with the eCabinet folder service button 165 selected and the eCabinet folder service window 193 displayed. In this example, the eCabinet folder button 165 has been selected and as a result the eCabinet folder service window 193 is displayed. The eCabinet folder service window 193 includes a folder list window 189, a refresh button 190, a selected window 191, and a reset button 192. The eCabinet folder service offers users the ability to scan to the eCabinet folder service. The eCabinet folder list is downloaded from the eCabinet server automatically using the configuration settings included in the config.xml file 7. When a user selects the eCabinet folder button 165, the unified client application 5 prompts the user with a software keyboard allowing the user to enter a user name and a password. The unified client application 5 then downloads the user's folder tree and displays the tree in the folder list window. Note that using the eCabinet folder service requires single owner selection. If multiple owners have been selected in eCabinet owner service window 173 and the user presses eCabinet folder button 165, an error message will pop up stating eCabinet folder service requires single owner selection. The folder list window 189 shows a user's eCabinet folder tree. The user can browse the folder tree in the folder list window 189. To add a destination folder, the user can highlight the desired folder in the folder list window 189 and press the right arrow button 175. To delete a destination folder in the selected window 191, the user can highlight the desired folder in the selected window 191 and press the left arrow button 176. It should also be noted that multiple folders can be selected. The refresh button 190 allows the user to download the eCabinet folder list again from the eCabinet server. If the refresh button 190 is pressed, the user will be prompted for the user name and password entry again. The reset button 192 allows all the contents placed in the selected window 191 to be removed. It should also be noted that the eCabinet folder list, included in the folder list window 189, is dependent upon the owner selected in the eCabinet owner service window 173 included in FIG. 12. The user that is selected and included in the selected window 170, is the user who corresponds to the folder list included in the folder list window 189.

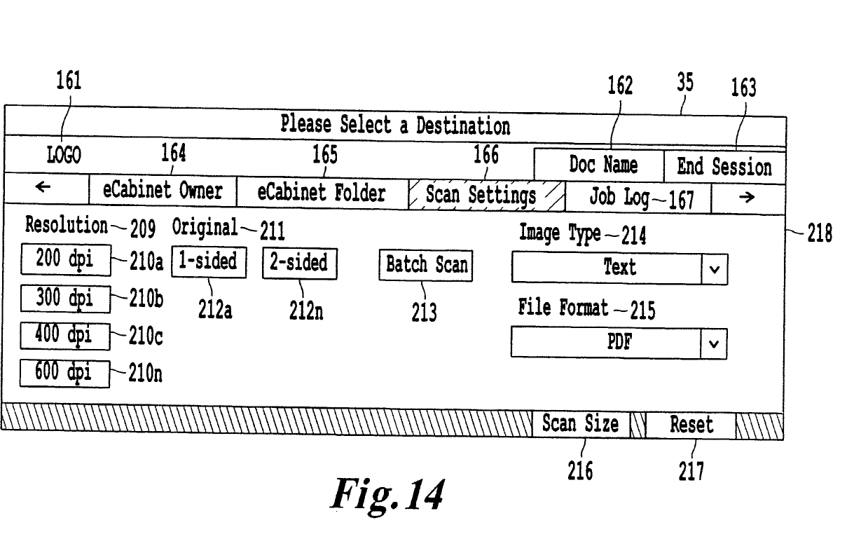

FIG. 14 shows the user interface for an example of when the scan settings button 166 is selected. When the scan settings 166 button is selected, the scan settings service window is displayed 218. The scan setting service window includes several options including resolution 209, original 211, image type 214 and file format 215. Under the resolution option 209, several different buttons relating to scanner resolution are used. In this example, DPI 200, 210a, 300 DPI, 210b, 400 DPI, 210c, or 600 DPI, 210n, are available to be selected. Other similar types of DPI options resolution options could also be used. The original option 211, includes two buttons. The first button 212a allows the one sided option to be selected. The second button 212n allows the two sided option to be selected. Further, a batch scan button is displayed 213. The image type option 214 also includes a drop-down menu listing a number of image types. In the current example, the text option is displayed. It should also be noted that in the image type drop-down box text, photo, gray scale or photo options are available. Similarly, under the file format option 215, a second drop-down box is included listing a number of different file formats. In the present example, the PDF option is displayed. However, in the file format drop-down box single page tiff, multi-page tiff, jpeg and PDF options are available. Also included on the scan setting service window 218 is a scan size 216 button and a reset button 217.

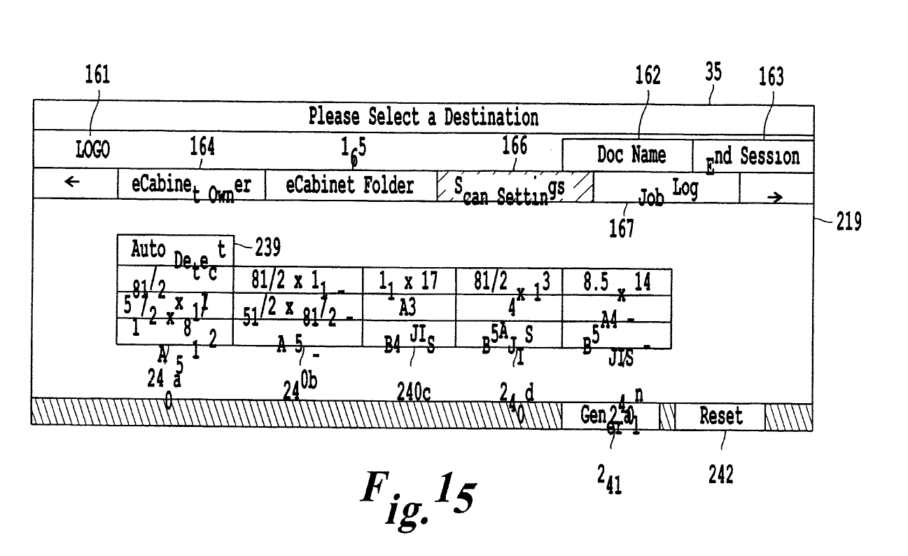

The scan size button 216 opens a new window which is shown in FIG. 15. The scan size window 219 is still part of the scan sittings service window 218. However, the scan size window 219 is displayed in place of the scan setting service window 218 under the main window 35. In the scan size window 219, several different options are available. For example, auto detect 239, 8×11 5½×8½ A5, 240a, 8½×11 5½×8½ A5 240b, 11×17 a3, B4 JIS 270c, 8½×13 A4 B5 JIS 240d, and 8½×14 A4 B5 JIS 240n. Also included are a reset button 242 and a general button 241 which returns the user to the original scan settings service window 218.

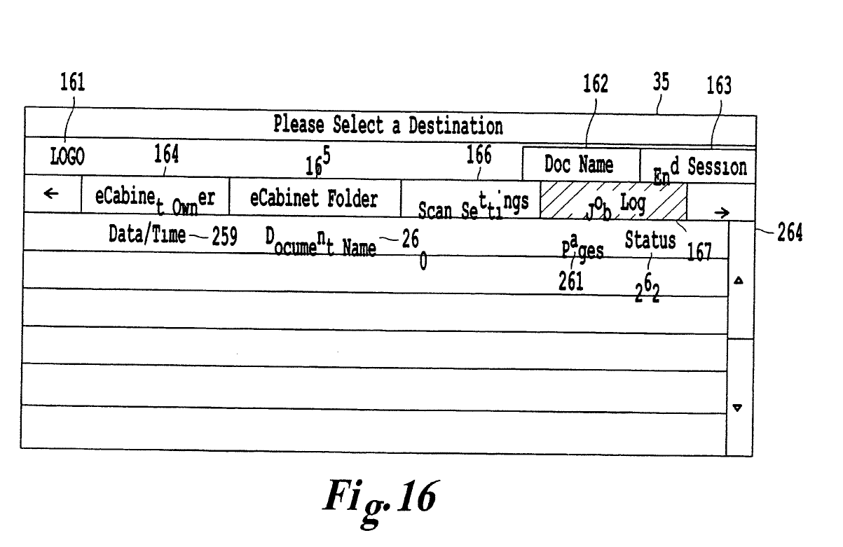

FIG. 16 shows the main window 35 and the job log service window 264 displayed when the job log button 167 is selected. In the job log service window 264, date and time 259, document name 260, pages 261 and status 262 titles are displayed. From the job log service window 264 users can check scan job upload status specifically through the date and time, the document name, number of pages and the status of the job. This concludes the MFP display example of the eCabinet Embedded Function 8b.

FIG. 17 shows the default service window 300 and main window 35 for the email project corresponding to the email function of the MFP. When a user selects the Email project in the project array window 32, the window shown in FIG. 17 is shown. The window shown is the same regardless if the embedded email function or the embedded email function has priority. As a result, the use of external functions by the MFP is transparent to the user.

The main window 35 of the email project includes the Email service button 301, the ScanSetting service button 166, and the JobLog button 167. The ScanSetting service button 166 and the JobLog button 167 correspond to ScanSetting and JobLog service windows which are very similar to the windows described above with respect to the eCabinet embedded function. Thus these service windows are not illustrated in the present example.

The email service window 300 includes a subject button 302 which when selected allows the user to enter an email subject in subject field 306. When the subject button 302 is selected, a keyboard is displayed that allows a user to enter in the subject (not shown). The recipient field 307 includes the names of the recipients of the email. Search button 303 enables the names of the addresses of the email recipients to be searched using an email address database such as an LDAP database. Alternatively, the manual entry button 304 allows the address of the recipient to be manually entered. Clear Form button 305 clears all of the addresses from the recipient field 307. Once the user has finished adding the addresses to the recipient field 307, the addresses can be moved to the “To” field 309, the “CC” field 310, the “Bcc” field 311 or the “Reply to” field 312 using the arrow buttons 308. The reset button 313 clears the “To”, “Cc”, “Bcc” and “Reply to” fields. Also included in the email service window 300 are doc name 162 and end session 163 buttons, these buttons are discussed above with respect to the eCabinet embedded function.

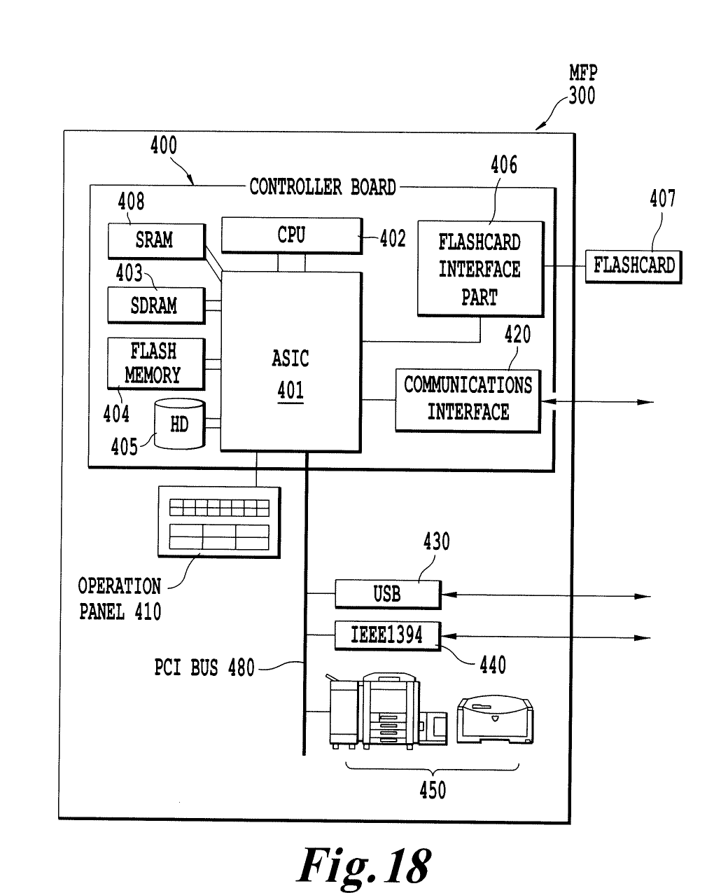

FIG. 18 shows an example of a hardware configuration of the MFP 499 according to an embodiment of the present invention. As shown in FIG. 18, the MFP 499 includes a controller board 400, an operation panel 410, a fax control unit (FCU) 420, a USB 430, an IEEE 1394 port 440, and a printer 450. It should be also noted that other types of i/o interfaces could be included including IEEE 1394b, USB 2.0. The controller board 400 includes a CPU 402 for processing and several storage devices such as SDRAM 403, SRAM 408, flash memory (flash ROM) 404, flash card interface part 406 and HD 405 used to store data associated with the MFP 499. Each of these components are connected to the ASIC 401, the ASIC 401 is an application specific integrated circuit that is designed specifically for use in a MFP 499. Other types of storage devices are also possible as well as other types of data processors and integrated circuits. The operation panel 410 is directly connected to the ASIC 401 as is the communications interface 420. The communications interface 420 can also be connected to a network or any other similar type communications medium. The USB 430, the IEEE 1394 440 and the multi-function printer functions 450 such as scanning, printing, and faxing are connected to the ASIC 401 via the PCI bus 480.

The SRAM 408 is a nonvolatile RAM, other types of SRAM are also possible. A flashcard 407 can be inserted into a flash card interface part 406, so that data is sent/received between the ASIC 401 and the flashcard 407 via the flash card interface part 406.

The operation panel 410 includes an operation part used for key operation such as key input and button pushing and the like by the user, and a display part for displaying drawing data such as various screens. It should be appreciated that other types of hardware components can be used in the present invention.

Further with respect to a computer readable medium such as a floppy disk, magnetic tape, CD-ROM and the like, by installing the program stored in the computer readable medium into an MFP, the MFP can perform the functions of the present invention.

This invention has been described with respect to a multifunction printer, but is applicable to any image handling device such as a copier, digital copier, printer, scanner, digital camera, fax machine, or multi-function printer or any combination thereof. A general purpose computer is not considered an image handling device. Moreover, the invention is applicable to other special purpose devices such as navigation systems, global positioning systems, vending machines, metering systems, machine tools and other tools which operate using programming or a programmed processor, automobiles, other transportation devices such as trains, motorcycles, planes, or boats, radar systems, radios, MP3 players, digital music players, and other audio systems, mobile phones, other communication devices and systems, and any other special purpose device which operates using a plug-in.

The present invention is not limited to the specifically disclosed embodiments, and variations and modifications may be made without departing from the scope of the present invention.

What is claimed is:

1. A method, comprising:
launching a host application of an image handling device, the image handling device including at least one embedded function and a network interface;
determining external functions for the image handling device, the external functions utilizing the network interface and including operations which are performed remotely from the image handling device;
storing information regarding available external functions determined by the determining in a configuration file;
presenting a graphical interface that includes selectable graphical indicia representing each function accessible on the image handling device including the at least one embedded function and the available external functions; and
executing the at least one embedded function and the determined external functions based on a selection of the corresponding graphical indicia.

2. The method according to claim 1, wherein the determining scans a network connected to the network interface to determine available external functions.

3. The method according to claim 1, wherein the determining connects to an external server that identifies available external functions and transmits information regarding the available external functions to the image handling device.

4. The method according to claim 1, wherein the determining uses a previously created configuration file as a basis for confirming the availability of external functions.

5. The method according to claim 4, further including:
determining priority of functions when an embedded function conflicts with an available external function.

6. The method according to claim 5, wherein the presenting presents graphical indicia based on the result of the determining priority of functions.

7. The method according to claim 6, wherein the graphical indicia presented corresponds only to function determined to have priority.

8. The method according to claim 5, wherein accessibility of the conflicting functions is used to determine priority.

9. The method according to claim 1, further comprising:
accessing the configuration file of the image handling device, the configuration file including information regarding the activation status of each function for the image handling device including both embedded and external functions; and
determining the accessibility of each function for the image handling device including both embedded and external functions using the configuration file.

10. The method according to claim 9, wherein the accessibility is determined based on the activation status of each function in the configuration file.

11. The method according to claim 1, wherein a log of the executing is stored on the image handling device.

12. The method according to claim 11, wherein the log is transmitted over the network for storage in a central repository.

13. The method according to claim 1, wherein the configuration file is an extensible markup language configuration file.

14. An image handling device, comprising:
a host application configured to provide a core service of the image handling device and including at least one embedded function and a network interface;
an external function unit configured to determine external functions for the image handling device, the external functions utilizing the network interface and including operations which are performed remotely from the image handling device;
a configuration file configured to store information regarding available external functions determined by the determining;
a display configured to present a graphical interface that includes selectable graphical indicia representing each function accessible on the image handling device including the at least one embedded function and the available external functions; and
an input unit configured to receive user input and to execute the selected at least one embedded function or the determined external function based on the selection of the corresponding graphical indicia.

15. The image handling device according to claim 14, wherein the external function unit scans a network connected to the network interface to determine available external functions.

16. The image handling device according to claim 14, wherein the external function unit connects to an external server that identifies available external functions and transmits information regarding the available external functions to the image handling device.

17. The image handling device according to claim 14, wherein the external function unit uses a previously created configuration file as a basis for confirming the availability of external functions.

18. The image handling device according to claim 17, further including:
a priority unit configured to determine a priority of functions when an embedded function conflicts with an available external function.

19. The image handling device according to claim 18, wherein the display presents graphical indicia based on the result of the determining of the priority unit.

20. The image handling device according to claim 19, wherein the graphical indicia presented corresponds only to function determined to have priority.

21. The image handling device according to claim 18, wherein accessibility of the conflicting functions is used to determine priority.

22. The image handling device according to claim 14, further comprising:
an activation unit configured to access the configuration file of the image handling device, the configuration file including information regarding the activation status of each function for the image handling device including both embedded and external functions; and
an accessibility unit configured to determine the accessibility of each function for the image handling device including both embedded and external functions using the configuration file.

23. The image handling device according to claim 22, wherein the accessibility unit determines the accessibility of each function based on the activation status of each function in the configuration file.

24. The image handling device according to claim 14, wherein a log of each function executed on the image handling device is stored on the image handling device.

25. The image handling device according to claim 24, wherein the log is transmitted over the network for storage in a central repository.

26. The image handling device according to claim 14, wherein the configuration file is an extensible markup language file.
